(19) United States
(12) Patent Application Publication
(10) Pub. No.: US 2017/0068751 A1
(43) Pub. Date: Mar. 9, 2017

(54) MANIFOLD SYSTEM AND SYNTHESIS OF A MANIFOLD SYSTEM FROM INPUT MODELS

(71) Applicant: SANKHYA TECHNOLOGIES PRIVATE LIMITED, Chennai (IN)

(72) Inventors: Gopi Kumar Bulusu, Visakhapatnam (IN); Murali Desikan, Chennai (IN)

(21) Appl. No.: 15/309,033

(22) PCT Filed: May 7, 2014
(86) PCT No.: PCT/IN2014/000309

§ 371 Date: Nov. 4, 2016

(51) Int. Cl. G06F 17/50; G06F 17/16

(52) U.S. Cl. CPC G06F 17/50; G06F 17/16; G06F 2217/16

(57) ABSTRACT

The present invention relates to a manifold system comprising: at least one manifold frame comprising an initial manifold configuration model, and a set of manifold planes, wherein each manifold plane comprises of a set of manifold elements, said manifold element is a concrete specialization of an abstract dimensioned entity supporting manifold operations such as configuration, projection, forming and transforming, etc, wherein such specializations comprises of compute elements, cognitive elements, transitive elements, processors, and/or transducer elements, or composite of these elements or composite of planes of these elements, etc, and variably progresses from manifold frame to frame in manifold time units through manifold system operations such as forming, transforming, projecting, computing, learning and transducing, etc in a real, virtual or a combination of real and virtual operating environment such as desktop operating system, distributed operating system, embedded operating system, field programmable gate array system, virtual system, and/or combination of real and virtual systems thereby performing useful work or duty. The present invention also relates a method of realizing a manifold system from input models.

### FIELD OF THE INVENTION

This invention relates to computer architecture, computer architecture modeling, computer architecture synthesis, high performance computing, parallel computing, topological computing, many-core systems and programming. In particular, the invention relates to a manifold system and synthesis of a manifold system from input models.

### BACKGROUND OF THE INVENTION

Many existing computers use what is termed as Von Neumann architecture and execute a program as a sequence of instructions accessed from memory through use of a program counter. These are termed as SISD computers. There are others that allow a single operation to be performed on multiple data streams (SIMD) often called vector processors or multiple operations to be performed on a single data stream (MISD). A general purpose parallel computer is like many SISD computers running in parallel and can be classified as multi-processor or many-core systems. Multi-instruction and/or multi-data (MIMD) stream computers can lead to higher performance and are suitable for applications such as supercomputing, high performance computing and big data processing.

The traditional computing systems treat compute elements, their relationships and the data on which they operate on as separate entities. The focus of these systems is primarily on the compute elements and how they are arranged. The data is treated as something on which the compute elements operate over time. While this model works well for sequential program execution, however, it does not scale well for parallel processing involving multi-dimensional heterogeneous nodes. These models fail to take into account the temporal and spatial parallelism inherent in the problem space, computational space and in the relationships between the different elements of the system.

Further, the existing systems focus primarily on decomposing computations into multiple threads and statically scheduling threads to processing elements to achieve parallelism.

One existing approach for parallelization of software programs to run on many processor cores is to process and analyze code written to execute serially and then transform it into parallel code. Examples include auto-parallelization options supported by compilers like gcc (Graphite) and, llvm (Polly). This approach may not result in an optimal solution since it does not have explicit information at the source level on which parts of the code are intended to be run concurrently on different threads or processor cores. Also, there exist frameworks like Intel Thread Building Blocks (TBB), OpenMP and CUDA which provide language and library facilities for specifying concurrent behavior, handling communication between different threads, synchronization and scheduling threads to run on multiple cores. These typically provide some programming directives or library functions to specify partitioning of computation into threads, synchronization between threads and for scheduling. The libraries available in these frameworks handle the partitioning of parallel tasks, data transfer, synchronization and other functionality. Parallel extensions to existing programming have enabled programmers to describe software that can run in parallel. Most such systems enable the programmer to explicitly describe parallelism in the code. However, all of these approaches suffer from the fundamental limitation of having to model computations as sequential programs and then to make these programs execute in a parallel manner.

In addition to the above, in multi-processor systems, processing elements access a copy of the data that they operate upon from a local memory or access data from a shared memory. Most programming models also support a memory-centric access to data. While this model works well for data accessed from a RAM, it does not work well when the data has to be obtained from external sources like databases, files and so on. The programmer has to explicitly take care of obtaining the data from different sources, perform any transformations on the data and then route it to the required processors. There is no uniformity in access to data from different sources.

Therefore in light of the above discussions, there is a need to solve above mentioned problems of the art.

### OBJECTS OF THE INVENTION

The principle object of the present invention is to provide highly generic computing system or agent which is a significant improvement over existing computing systems to solve the above mentioned problems of the art.

Another object of the invention is to provide programming constructs to model a manifold system.

Yet another object is to synthesize a manifold system from input models.

A still another object of the invention is to provide a method of accessing temporal and spatial data from one or more sources in a manifold system as well as to provide uniformity in accessing the temporal and spatial data from the one or more sources.

### SUMMARY OF THE INVENTION

Before the present methods, apparatuses and hardware enablement are described, it is to be understood that this invention is not limited to the particular methodologies, and apparatuses described, as these may vary. It is also to be understood that the terminology used in the description is for the purpose of describing the particular versions or embodiments only, and is not intended to limit the scope of the present invention which will be limited only by the appended claims.

### DEFINITIONS/GLOSSARY

A dimensioned entity is a multi-faceted entity which supports one or more interfaces.

A fold is a discontinuity in space or time.

A manifold element is a concrete specialization of an abstract dimensioned entity.

A compute element is a manifold element that can perform one or more computations.

A cognitive element is a manifold element with the ability to learn the mapping between its inputs and outputs.

A transitive or transitive element is a manifold element which specifies the relationship between other manifold elements.

A transducer is a manifold element that converts signals from one form to another. These forms may include electrical, mechanical, electromagnetic, thermal, and chemical, etc.

A runner is a manifold element that instantiates another manifold element

An operating environment is a set of interfaces that allow a manifold system to form and perform work.

Earth date is the date as set in an operating environment

A signal is a data element with a specific type and size.

A sensor is a component which senses the change in state of another component and signals it in a suitable form.

An activator is a component which activates another component based on the stimulus it receives.

A progressive is a model of a compute element described through blocks of algebraic equations. A progressive specifies an interface which includes sensor inputs and actuator outputs. A progressive may expose multiple behaviors as part of different blocks corresponding to different dimensions of the compute element. These blocks are named as east, west, north, south, front and back.

A hard progressive is a progressive that can be realized as hardware.

A soft progressive is a progressive that can be realized as software.

A computational universe is a collection of progressives.

A computational manifold is a multi-dimensional array of heterogeneous compute elements, cognitive elements and transducer elements.

A data manifold is a multi-dimensional array of data of a specific type.

An edge is an interface between a manifold system and its external environment.

Temporal input is an input that changes over time.

Spatial input is an input that is spread over space and can be accessed as a vector.

A slice is a particular dimension selected from an N-dimensional space of manifold elements.

A projection is a mapping of a plane of manifold elements onto another plane of manifold elements or operating environment elements.

Multi-ladder synthesis is a step-by-step refinement of a manifold system model into structural and behavioral descriptions of different levels of abstraction.

Unified model is a model that specifies the equivalence of multiple input grammars as disclosed in the U.S. Pat. No. 7,529,658 to Bulusu et al, the entire contents of which is incorporated by reference herein.

Processor architectural model is a unified model of the instruction-set architecture (ISA) of a microprocessor which specifies the equivalence between the elements of the ISA in behavioral, assembly and machine code representations. An example of a language that can be used to describe the ISA of a processor as a unified model is the SANKHYA Machine Description Language (SMDL) developed by Sankhya Technologies (http://www.sankhya.com/info/products/tools/docs/smdl.pdf).

Space-time model is a unified model which specifies the equivalence between the behaviors of compute elements described using procedural and gate-level representations.

A High-level Description is a programmatic description of the elements of a manifold system. One language used for high-level descriptions is the Progressive C language which is described in this invention.

An Intermediate Level Description is a description of the structure and behavior of a manifold system that is between the high-level description and the final software or hardware descriptions. An example of a language that can be used for specifying intermediate level descriptions is the Common Behavior Description Language (CBDL) from Sankhya Technologies (http://www.sankhya.com/info/support/khub/pdfs/TeraptorUGRM.pdf).

An operator model is a set of user-defined operators described using an intermediate level description

A transformation is a function that maps a value v1 conforming to a model m1 to a corresponding value v2 conforming to a model m2.

A model transformation is a transformation specified in terms of model elements.

A value transformation is a transformation specified in terms of values.

Processor Abstraction Layer (PAL) is an abstraction that allows system programs to access processor functionality in an implementation independent way.

Hardware Abstraction Layer (HAL) is an abstraction that allows programs to access system hardware functionality in an implementation independent way.

The present invention provides a manifold system and synthesis of a manifold system from input models to solve the problems mentioned in the art.

According to one embodiment of the invention, a manifold system is a highly generic autonomous computing system or agent which is a significant improvement over existing systems in that it unifies multidimensional planes of compute elements, relationship elements, and data elements and operates as a single entity which progresses in manifold time by means of manifold system operations to perform useful work.

In a preferred embodiment of the invention, the manifold system comprises of at least one manifold frame. The manifold frame comprises of an initial manifold configuration model and a set of manifold planes, wherein the manifold plane comprises of a set of manifold elements. The manifold system variably progresses from manifold frame to frame in manifold time units through manifold system operations in a real, virtual or a combination of real and virtual operating environment thereby performing useful work or duty. The manifold system operations comprises of forming, transforming, projecting, computing, learning and transducing, etc. The operating environment comprises of any one of the followings such as desktop operating system, distributed operating system, embedded operating system, field programmable gate array system, virtual system, or combination of real and virtual systems, etc.

The manifold element is a concrete specialization of an abstract dimensioned entity supporting manifold operations like configuration, projection, forming and transforming. The concrete specializations include compute elements, cognitive elements, transitive elements, processors, transducer elements, or composite of these elements or composite of planes of these elements, etc. Each component of the manifold system has a specific location in the manifold space.

According to another embodiment of the invention, a method is provided for realizing a manifold system from input models, in which steps thereof are implemented by a computer, the method comprising the following steps:

Initially, a computational manifold is modeled as multiple planes of compute elements conforming to behavioral models and their relationships. In the next step of the method, a data manifold is modeled as multiple planes of problem elements. The computational manifold and the data manifold may be modeled using a declarative programming language or using extensions to programming languages such as C and C++. The computational manifold and the data manifold may also be modeled using any of the programming languages which is suitable to model the computational manifold and the data manifold and is known to the person skilled in the art.

In the next step, a projection of the data manifold onto the computational manifold is modeled. The projection may be modeled using play statements. The projection may also be modeled using other programming constructs which are suitable to model the projection and is known to the person skilled in the art.

In the next step, a manifold system of required model type and level of abstraction is synthesized. The manifold system may be synthesized using multi-ladder approach, wherein the manifold elements may be synthesized at different levels of abstraction. The manifold system may also be synthesized using any one of the approach or technique which is suitable to synthesize the manifold system and is known to the person skilled in the art.

In the final step, a schedule is synthesized which projects the data manifold onto the computational manifold to solve a given problem.

According to yet another embodiment of the invention, a declarative programming language is provided to model multitude of planes of compute elements, cognitive element elements, transducer elements, relationship elements and problem data elements as components of a manifold system and also to support the modeling of the projection of the planes of manifold elements to other planes of manifold elements. This allows the concurrency inherent in the problem to be directly modeled instead of the procedural approach used in existing methods to model the solution as a sequential program which is then made to execute in parallel. The programming language also allows declaring processor architectural models in programs and allows affinity for processor models to be set for compute elements. Also, the programming system allows operators specified in external operator models and space-time models to be used in programs thereby providing extensible algebraic expressive power. The extensible programming model allows new operators to be synthesized at many levels of abstraction—viz. as intermediate level functions, as high-level language functions, as hardware description at Register Transfer Level (RTL), gate-level and transistor-level, etc.

According to yet further embodiment of the invention, an apparatus and a method are provided for synthesizing a manifold system as a hierarchical model from a set of models describing the problem and the manifold elements.

According to another embodiment of the invention, an apparatus is provided for realizing a manifold system from input models, comprising the followings such as means for modeling a computational manifold as multiple planes of compute elements conforming to behavioral models and their relationships, means for modeling a data manifold as multiple planes of problem elements, means for modeling a projection of the data manifold onto the computational manifold, means for synthesizing a manifold system of required model type and level of abstraction, and means for synthesizing a schedule which projecting the data manifold onto the computational manifold to solve a given problem.

According to another embodiment of the invention, a non-transitory computer readable medium is provided for realizing a manifold system from input models, including program instructions executable by a computer for the following steps:

Initially, a computational manifold is modeled as multiple planes of compute elements conforming to behavioral models and their relationships. In the next step of the method, a data manifold is modeled as multiple planes of problem elements. In the next step, a projection of the data manifold onto the computational manifold is modeled. In the next step, a manifold system of required model type and level of abstraction is synthesized, and finally, a schedule is synthesized which projects the data manifold onto the computational manifold to solve a given problem.

According to another embodiment of the invention, a computer program is provided, the program comprising program code stored in a non-transitory computer readable medium, the program code executable by a computer to carry out the method for realizing a manifold system from input models.

According to another embodiment of the invention, a computer program is provided, the program comprising program code stored in a non-transitory computer readable medium, the program code executable by a computer to carry out the method for realizing a manifold system from input models, the program code arranged for being integrated in or added to a computer application for joint execution of said computer program and said computer application by said computer.

According to another embodiment of the invention, a computer program product is provided, the product comprising program code stored on a non-transitory computer readable medium, the program code readable by a computer, which operates to carry out the method for realizing a manifold system from input models, when said program code is executed by said computer.

According to another embodiment of the invention, a computer program product is provided, the product comprising program code stored on a non-transitory computer readable medium, the program code readable by a computer, which is operable to carry out the method for realizing a manifold system from input models, and further comprising integrating said program code into a computer application for joint execution of said program code and said computer application by said computer.

According to another embodiment of the invention, a method is provided for accessing at least one temporal and spatial data from at least one source in a manifold system, the method comprising the following steps:

Initially, the at least one temporal and spatial data from the at least one source to signals of the compute elements is mapped using a transitive element of the manifold system, wherein i) the transitive element specifies the relationship between a) a set of data elements, b) the data elements and the compute elements, or c) the compute elements; ii) the data elements along with their sources are declared using a transitive declaration.

In the final step, the at least one temporal and spatial data from the at least one source is accessed thereby mapping a source address to a target address using a channel by the following steps:

Initially, a channel map instance and an address are accepted as inputs. In the next step, for each entry in the channel map instance, whether the input address is within the range of start and end addresses of that entry is checked. In the next step, the address of the Nth byte of data from the target address stored in the entry is retrieved, in case the input address is within the range of start and end addresses of that entry, wherein N is the difference between the input address and the start address stored in the entry. The sources comprises of any one of the followings such as local file system, network file system, database and web location, etc.

According to yet another embodiment of the invention, a transitive element is provided which specifies a relationship between sets of data elements or between data elements and compute elements and between compute elements of computing system. A transitive element maps data from different sources to signals of compute elements. In addition, the programmer declares the data elements along with their sources using a transitive declaration. Finally, the transitive element may handle the tasks of obtaining data from the specified sources in a manner transparent to the compute elements.

According to another embodiment of the invention, an apparatus is provided for accessing at least one temporal and spatial data from at least one source in a manifold system, comprising the followings such as means for mapping the at least one temporal and spatial data from the at least one source to signals of the compute elements using a transitive element of the manifold system, wherein i) the transitive element specifies the relationship between a) a set of data elements, b) the data elements and the compute elements, or c) the compute elements; ii) the data elements along with their sources are declared using a transitive declaration; and means for accessing the at least one temporal and spatial data from the at least one source thereby mapping a source address to a target address using a channel by: i) accepting a channel map instance and an address as inputs; ii) for each entry in the channel map instance, checking whether the input address is within the range of start and end addresses of that entry; and iii) retrieving the address of the Nth byte of data from the target address stored in the entry, in case the input address is within the range of start and end addresses of that entry, wherein N is the difference between the input address and the start address stored in the entry. The sources comprises of any one of the followings such as local file system, network file system, database and web location, etc.

According to another embodiment of the invention, a non-transitory computer readable medium is provided for accessing at least one temporal and spatial data from at least one source in a manifold system, including program instructions executable by a computer for the following steps:

Initially, the at least one temporal and spatial data from the at least one source to signals of the compute elements is mapped using a transitive element of the manifold system, wherein i) the transitive element specifies the relationship between a) a set of data elements, b) the data elements and the compute elements, or c) the compute elements; ii) the data elements along with their sources are declared using a transitive declaration.

In the final step, the at least one temporal and spatial data from the at least one source is accessed thereby mapping a source address to a target address using a channel by the following steps:

Initially, a channel map instance and an address are accepted as inputs. In the next step, for each entry in the channel map instance, whether the input address is within the range of start and end addresses of that entry is checked. In the next step, the address of the Nth byte of data from the target address stored in the entry is retrieved, in case the input address is within the range of start and end addresses of that entry, wherein N is the difference between the input address and the start address stored in the entry. The sources comprises of any one of the followings such as local file system, network file system, database and web location, etc.

According to another embodiment of the invention, a computer program is provided, the program comprising program code stored in a non-transitory computer readable medium, the program code executable by a computer to carry out the method of accessing at least one temporal and spatial data from at least one source in a manifold system.

According to another embodiment of the invention, a computer program is provided, the program comprising program code stored in a non-transitory computer readable medium, the program code executable by a computer to carry out the method of accessing at least one temporal and spatial data from at least one source in a manifold system, the program code arranged for being integrated in or added to a computer application for joint execution of said computer program and said computer application by said computer.

According to another embodiment of the invention, a computer program product is provided, the product comprising program code stored on a non-transitory computer readable medium, the program code readable by a computer, which operates to carry out the method of accessing at least one temporal and spatial data from at least one source in a manifold system, when said program code is executed by said computer.

According to another embodiment of the invention, a computer program product is provided, the product comprising program code stored on a non-transitory computer readable medium, the program code readable by a computer, which is operable to carry out the method of accessing at least one temporal and spatial data from at least one source in a manifold system, and further comprising integrating said program code into a computer application for joint execution of said program code and said computer application by said computer.

The methods, systems, apparatuses, non-transitory computer readable mediums, computer programs and computer program products of the present invention find application in the areas of computer graphics, image processing, aerodynamic modeling, big data applications such as query processing, analytics, mapping, machine learning, cognitive element computing, 2-D, 3-D Chip design, multi-core computing, shape computing, topological computing, 3-D printing, robotics, Internet of Things (I-o-T), Swarm Internet of Things, Cognitive I-o-T, medical imaging, space modeling, environmental modeling, distributed operating system, mobile network simulation, N-tier Service Oriented Architecture (SOA), Self-Programmable Gate Array (SPGA) Design, SPGA Application Design, and design slicing using model layer extension.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings example constructions of the invention; however, the invention is not limited to the specific methods, apparatuses and systems disclosed. In the drawings:

FIG. 1 shows an exemplary system with which the methods according to the present invention may be implemented.

FIG. 2 shows a block diagram of a manifold system according to one exemplary embodiment of the invention.

FIG. 3 shows a block diagram of the progression of a manifold system from frame to frame in manifold time according to one exemplary embodiment of the invention.

FIG. 4 shows a diagram of the process of projecting a one dimensional data manifold to a two-dimensional data manifold according to one exemplary embodiment of the invention.

FIG. 5 shows a diagram showing the projection of a two-dimensional plane of data elements onto a two-dimensional plane of compute elements according to one exemplary embodiment of the invention.

FIG. 6 shows the steps of a method for realizing a manifold system from input models according to one exemplary embodiment of the invention.

FIG. 7 shows the steps of the multi-ladder synthesis method for synthesizing a manifold system from inputs models which describe the compute elements and their relationships as shown in the step 640 of FIG. 6.

FIG. 8 shows the steps of a method for synthesizing a schedule which projects a data manifold onto a computational manifold for solving a given problem as shown in the step 650 of FIG. 6.

FIG. 9 shows the steps of a method for transforming a high-level manifold system model to software models for distributed computing according to one exemplary embodiment of the invention.

FIG. 10 shows the steps of a method for transforming a high-level manifold system model to software models for system simulation according to one exemplary embodiment of the invention.

FIG. 11 shows the steps of a method for transforming a high-level manifold system model to Register Transfer Language for hardware synthesis according to one exemplary embodiment of the invention.

FIG. 12 shows the steps of a method for transforming a high-level manifold system model to a software component model according to one exemplary embodiment of the invention.

FIG. 13 shows the steps of a method for transforming a high-level manifold system model to a structural model according to one exemplary embodiment of the invention.

FIG. 14 shows the steps of a method for transforming a software component model of a manifold system into client-server models for distributed computing according to one exemplary embodiment of the invention.

FIG. 15 shows the steps of a method for transforming a software component model of a manifold system into simulation component models according to one exemplary embodiment of the invention.

FIG. 16 shows the steps of a method for transforming an architectural model or a space-time model into structural model according to one exemplary embodiment of the invention.

FIG. 17 shows the steps of a method for transforming an architectural model, space-time model or an operator model into a behavioral model according to one exemplary embodiment of the invention.

FIG. 18 shows the steps of a method for transforming structural models of processors or compute elements into simulation models according to one exemplary embodiment of the invention.

FIG. 19 shows the steps of a method for transforming behavioral models into simulation models according to one exemplary embodiment of the invention.

FIG. 20 shows the steps of a method for transforming structural models of processors or compute elements into hardware models according to one exemplary embodiment of the invention.

FIG. 21 shows the steps of a method for transforming behavioral models of processors or computations elements into hardware models according to one exemplary embodiment of the invention.

FIG. 22 shows the steps of a method for synthesizing a software channel from the model of a transitive according to one exemplary embodiment of the invention.

FIG. 23 shows the steps of a method for mapping a source address to a target address using a transitive channel according to one exemplary embodiment of the invention.

### DETAILED DESCRIPTION OF THE INVENTION

Many of the functional units described in this specification have been labeled as means, in order to more particularly emphasize their implementation independence. For example, means may be implemented as a hardware circuit comprising custom VLSI circuits or gate arrays, off-the-shelf semiconductors such as logic chips, transistors, or other discrete components. A means may also be implemented in programmable hardware devices such as field programmable gate arrays, programmable array logic, programmable logic devices or the like.

Means may also be implemented in software for execution by various types of processors. An identified means of executable code may, for instance, comprise one or more physical or logical blocks of computer instructions which may, for instance, be organized as an object, procedure, or function. Nevertheless, the executables of an identified means need not be physically located together, but may comprise disparate instructions stored in different locations which, when joined logically together, comprise the module and achieve the stated purpose for the means.

Indeed, a means of executable code may be a single instruction, or many instructions, and may even be distributed over several different code segments, among different programs, and across several memory devices. Similarly, operational data may be identified and illustrated herein within means, and may be embodied in any suitable form and organized within any suitable type of data structure. The operational data may be collected as a single data-set, or may be distributed over different locations including over different storage devices, and may exist, at least partially, merely as electronic signals on a system or network.

Reference throughout this specification to ‘one embodiment’, ‘one exemplary embodiment’, ‘another embodiment’ or similar language means that a particular feature, structure, or characteristic described in connection with the embodiment is included in at least one embodiment of the present invention. Thus, appearances of the phrases ‘one embodiment’, ‘one exemplary embodiment’, ‘another embodiment’ or similar language throughout this specification may, but do not necessarily, all refer to the same embodiment.

Reference to a non-transitory computer readable medium may take any form capable of generating a signal, causing a signal to be generated, or causing execution of a program of machine-readable instructions on a digital processing apparatus. A non-transitory computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as example of programming, program code and computer program product to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The present invention will be described with respect to particular embodiments and with reference to certain drawings but the invention is not limited thereto but only by the Claims. Any reference signs in the Claims shall not be construed as limiting the scope. The drawings described are only schematic and are non-hinting. In the drawings, the size of scope of the elements may be exaggerated and not drawn on scale for illustrative purposes. Where the term “comprising” is used in the present description and Claims, it does not exclude other elements or steps. Where an indefinite or definite article is used when referring to a singular noun e.g. “a” or “an”, “the”, this includes a plural of that noun unless something else is specifically stated

Furthermore, the terms first, second, third, initially, next step, finally and the like in the description and in the claims, are used for distinguishing between similar steps and not necessarily for describing a sequential or chronological order. It is to be understood that the terms so used are interchangeable under appropriate circumstances and that the embodiments of the invention described herein are capable of operation in other sequences than described or illustrated herein.

The present invention provides a manifold system and synthesis of a manifold system from input models to solve the problems mentioned in the art. By way of explanation and example, the present invention will be described in detail below using following methods, apparatuses, and systems:

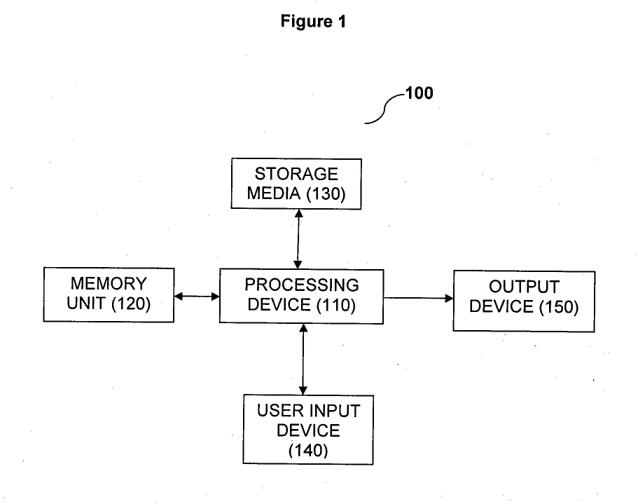

FIG. 1 shows an exemplary system 100 with which the methods according to the present invention may be implemented. The system 100 comprises of processing device 110, memory unit 120, storage media 130, user input device 140 and output device 150.

According to one aspect of the invention, the processing device 110 comprises of any one of the followings such as processor, microprocessor, controller, computer, central processing unit (CPU) or combination of these hardware, etc based on the requirements.

In another aspect, the processing device 110 may be connected with one or more other processing devices (not shown) to form a network of processing devices via communication network, wherein the other processing devices may be processor, microprocessor, controller, computer, central processing unit (CPU) or combination of these hardware, etc based on the requirements. In one exemplary aspect, the communication network may be selected from any one of the followings such as wired or wireless communication network. In a preferred aspect, the communication network is an internet.

In one aspect, the memory unit 120 may be coupled to the processing device 110, wherein the memory unit comprises of RAM, ROM, and any other storage memory unit known in the art based on the requirements of the computing system 100. The memory unit 120 may be used for storing
i. program instructions executable by the processing device 110 for executing the methods according to the present invention;
ii. input received from a user via user input device 140; and
iii. output received from the processing device 110.

In one aspect, the storage media 130 may be coupled to the processing device 110, wherein the storage media 130 comprises of RAM, ROM, and any other storage media known in the art based on the requirements of the computing system 100. The storage media 130 may be used for storing
i. program instructions executable by the processing device 110 for executing the methods according to the present invention;
ii. input received from the user via user input device 140; and
iii. output received from the processing device 110.

In another aspect, the storage media 130 may be an optional device and for providing additional storage space in the computing system 100.

In one aspect, the user input device 140 may be coupled to the processing device 110, wherein the user input device 140 may be a keyboard or any other device which can provide information signals to the processing device 110.

In one aspect, the output device 150 may be coupled to the processing device 110, wherein the output device 150 may be a display device which can show the output of the processing device 110 in any format comprising text, audio, video, and combination of these, etc.

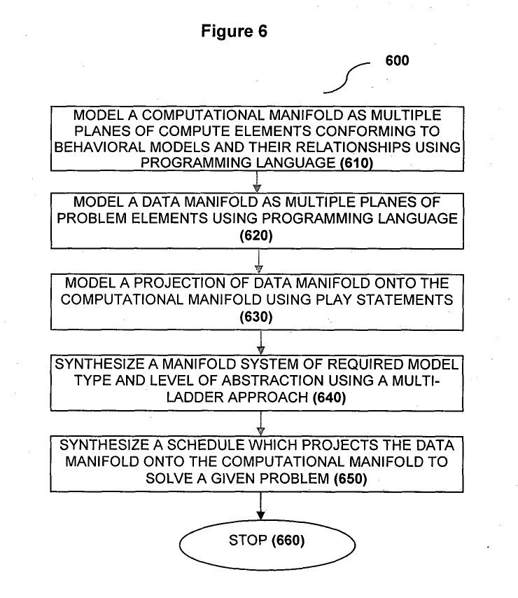

In another aspect, the methods according to the present invention may be implemented by using the processing device 110, memory unit 120, storage media 130, user input device 140, and output device 150 connected to the processing device 110. According to the present invention, the method for realizing a manifold system from input models is shown in FIG. 6.

The method for realizing a manifold system from input models, generally designated as 600, carried out according to the principles of the present invention.

In the first step 610 of the method 600, a computational manifold is modeled as multiple planes of compute elements conforming to behavioral models and their relationships. The computational manifold may be modeled using programming language such as C and C++, etc. The computational manifold may also be modeled using any one of the programming language which is suitable to model the computational manifold and is known to the person skilled in the art.

In the next step 620, a data manifold is modeled as multiple planes of problem elements. The data manifold may be modeled using programming language such as C and C++, etc. The data manifold may also be modeled using any one of the programming language which is suitable to model the data manifold and is known to the person skilled in the art.

In the next step 630, a projection of the data manifold onto the computational manifold is modeled. The projection is modeled using play statements. The projection may also be modeled using any one of the programming language which is suitable to model the projection and is known to the person skilled in the art.

In the next step 640, a manifold system of required model type and level of abstraction is synthesized. The manifold system may be synthesized using multi-ladder approach. The projection may also be modeled using any one of the approach or technique which is suitable to synthesize the manifold system and is known to the person skilled in the art.

An input to the above said synthesis process may be any one of the followings such as high-level description of problem elements and computations elements, C/C++ component model describing the structure and behavior of manifold elements, processor architectural model, space-time model, operator model, an intermediate level description of the structure and behavior of manifold elements, high-level description of problem elements and computations elements, C program, an assembly language program, register-transfer level description of the structure and behavior of manifold elements, logic gate-level description of the structure and behavior of manifold elements, and transistor-level description of the structure and behavior of manifold elements, etc.

An output of the above said synthesis process may be any one of the followings such as C/C++ component model describing the structure and behavior of manifold elements, intermediate level description of the structure and behavior of manifold elements, C/C++ model for simulation, distributed component model describing the structure and behavior of manifold elements, register-transfer level description of the structure and behavior of manifold elements, logic gate-level description of the structure and behavior of manifold elements, transistor-level description of the structure and behavior of manifold elements, integrated circuit layout description, assembly language program, relocatable object module, executable program, processor abstraction layer library, hardware abstraction layer library, and set of test cases for processor verification, etc.

In the final step 650, a schedule is synthesized which projects the data manifold onto the computational manifold to solve a given problem.

The method 600 ends in a step 660.

### Manifold System

According to one exemplary embodiment of the invention, a manifold system is an autonomous computing system or agent that exists in an operating environment and variably progresses from one manifold frame to another to perform some work, which may involve saving and restoring the state of the system or be mechanical in nature.

A manifold frame is a set of manifold planes at a particular instance of manifold time. Each manifold plane consists of a set of manifold elements. A manifold element is a dimensioned entity that supports certain interfaces and can perform some computation, or can learn from its inputs and outputs, or specify a relationship between other manifold elements, or can be a data element, or a composite of these or a plane of manifold elements. Each dimension of a manifold element can have different attributes and possibly exhibit different behavior. Each compute element of a manifold system can be a SISD, SIMD, MISD, MIMD computer. Also, an element of a manifold system can be part of multiple systems. For example, a database component can be part of multiple manifold systems at the same time.

Each manifold element in a manifold plane is of a specific type. A compute element performs one or more computations possibly in more than one dimension. A cognitive element learns about the mapping between its input and output. A transducer element converts signals from one form to another. A transitive element specifies relationships between other elements of a manifold system. The relationship is specified as a mapping between the signals of the manifold elements. A series of transitive elements allow hierarchical access to data leading to the concept of a telescopic state. A transitive allows a spatial signal to be accessed as a random-access memory object. A temporal signal can be accessed as a stream with a window of size N being loaded or stored on each access. The source (destination) from (to) which the data is streamed into (out of) the manifold system could be a local file system, a network file system, a database, a web location etc. In a transitive, mapping functions can be specified for each signal to transform the input or output data.

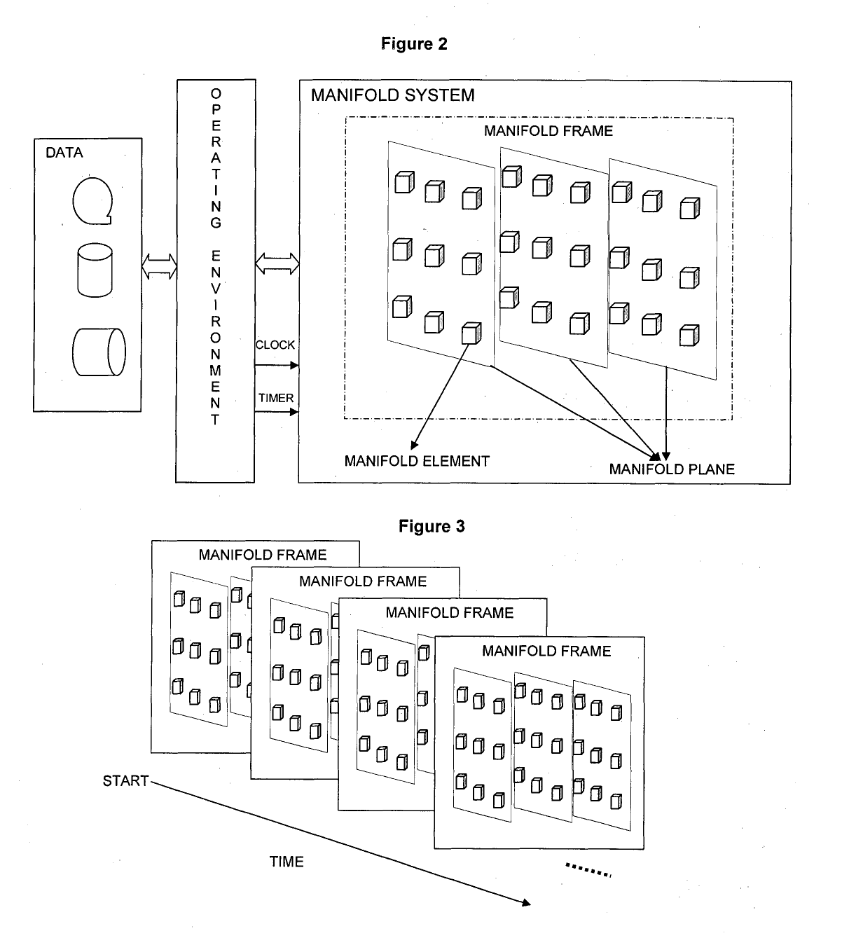

FIG. 2 shows a block diagram of a manifold system according to one exemplary embodiment of the invention. A manifold system comprises of an initial manifold frame which comprises of multitude of planes of manifold elements. Each of the manifold elements is a dimensioned entity that can perform some computation, or learn, or convert signals from one type to another or specify a relationship between manifold elements, can be a data element or of any other type. The relationships between manifold elements are specified using transitive elements. Each element in a manifold plane could be a composite element which contains other manifold elements, could be a manifold plane or even another manifold system.

In one exemplary aspect of the invention, a manifold system and its elements support one or more interfaces for forming and progressing. These include (but are not limited to) the following.

The former interface supports the operations form, fork and release. The form operation allocates a resource, the fork operation makes a copy of an existing resource and the release operation releases a resource.

The transformer interface supports adding and deleting transitive elements through the transform operation.

The projector interface is associated with a composite manifold element, a manifold plane, a manifold frame and manifold system. It supports a project operation to project data elements to data elements, data elements to progressives, progressives to runners and runners to operating environment elements.

The configuration interface is associated with a manifold system. It supports set and get operations to set and get configuration parameters.

The compute interface is associated with compute elements. It supports a compute operation which performs the computations associated with the element.

The cognitive interface is associated with cognitive elements. It supports a learn operation which causes a cognitive element to learn the mapping between its inputs and outputs.

The transducer interface is associated with transducer elements. It supports a convert operation to convert the input of a transducer element to an output of different type.

The security interface supports operations for authenticating requests for accessing resources and setting and getting user credentials.

The location interface supports operations for setting and getting the current location of a manifold element in a manifold network. The get_current_operation returns the current location of a manifold system or element within a network of manifold systems. The set_current_location operation sets the location of a manifold system or element. The roaming operation specifies whether the location of a manifold element is fixed or it varies with time. This can be useful when simulating a mobile network.

The kinetic interface supports operations related to moving objects.

The media interface supports operations related to audio and video processing.

### Operating Environment

According to one exemplary embodiment of the invention, a manifold system operates in a heterogeneous operating environment. The operating environment provides a set of interfaces that allows a manifold system to form and work. A manifold system starts with an initial frame that includes an initial set of manifold planes and an initial manifold configuration model. The configuration model specifies flags which control allocation of resources from the operating environment, scheduling parameters, placement of manifold elements, ratio of hardware and software resources to be used, etc.

According to another exemplary embodiment of the invention, a manifold system lives and operates in a heterogeneous operating environment. This can be a real environment—for example, an FPGA or embedded hardware and/or a virtual environment—for example, a simulated environment or a distributed system. An operating environment provides a set of interfaces that allows a manifold system to form and perform work. This set of interfaces includes a former interface for resource allocation and de-allocation, a timer interface which controls the progress of a manifold system and a clock interface which supplies the current time of the operating environment. An operating environment could support the Portable Operating System Interface (POSIX) specified by the IEEE to provide services to one or more manifold systems.

The basic interfaces supported by an operating environment are described below. An operating environment could support additional interfaces as required by specific manifold systems.

The former interface supports the operations form, fork and release. The form operation allocates a resource, the fork operation makes a copy of an existing resource and the release operation releases a resource.

The clock interface supports the operations get time and set_time. The get_time operation returns the current earth time and the set_time operation sets the current time.

The timer interface supports the operations sleep and wakeup. The sleep operation causes a manifold system to go into standby mode for the specified time units. The wakeup operation causes a manifold system to resume its operation.

The location interface supports the operations get_current_location, set_current_location and roaming. The get_current_location operation returns the current location of a manifold system or element within a network of manifold systems. The set_current_location operation sets the location of a manifold system or element. The roaming operation specifies whether the location of a manifold element is fixed or it varies with time. This can be useful when simulating a mobile network.

### Manifold System Operation

According to one exemplary embodiment of the invention, the operation of a manifold system is initiated and continued by means of manifold operations. A forming operation adds or removes manifold elements from the system. A transforming operation adds or removes transitive elements. A projection operation projects one manifold plane to another. A wakeup operation causes the system and its components to resume their operation. A sleep operation causes the system and its components to go to a waiting state. In addition to these, element level operations include (but are not limited to) computing, learning and transducing, etc. Once initiated, a manifold system variably progresses from one manifold frame to another. The term “variably progresses” means that each component of a manifold system progresses at its own rate leading to a hierarchical time path within the system.

FIG. 3 shows a block diagram of the progression of a manifold system from frame to frame in manifold time according to one exemplary embodiment of the invention. The operation of a manifold system is initiated by the operating environment through a wakeup operation. The manifold system starts with an initial frame and progresses from frame to frame through manifold operations. A static schedule is used to initially map the manifold elements to a set of runners. Different types of runners can exist depending on the operating environment. A manifold element can be mapped to a distributed system runner or a FPGA runner etc. The runner instantiates the manifold element and brings it into existence. Once the initial frame is instantiated, the manifold system can proceed by means of further manifold operations.

A form operation causes manifold elements to be added to the system. For example, a form operation can cause a two-dimensional matrix to be read from an input file and to be added as a manifold plane to the manifold system. A release operation on a manifold element causes the element to be removed from the system.

A transform operation results in addition of transitive elements. For example, when a compute element operates on each row of a two-dimensional matrix, a transform operation adds a transitive element between the compute element and the source of the matrix. The transitive element ensures that each row of the matrix is made available to the compute element whenever it requests another row.

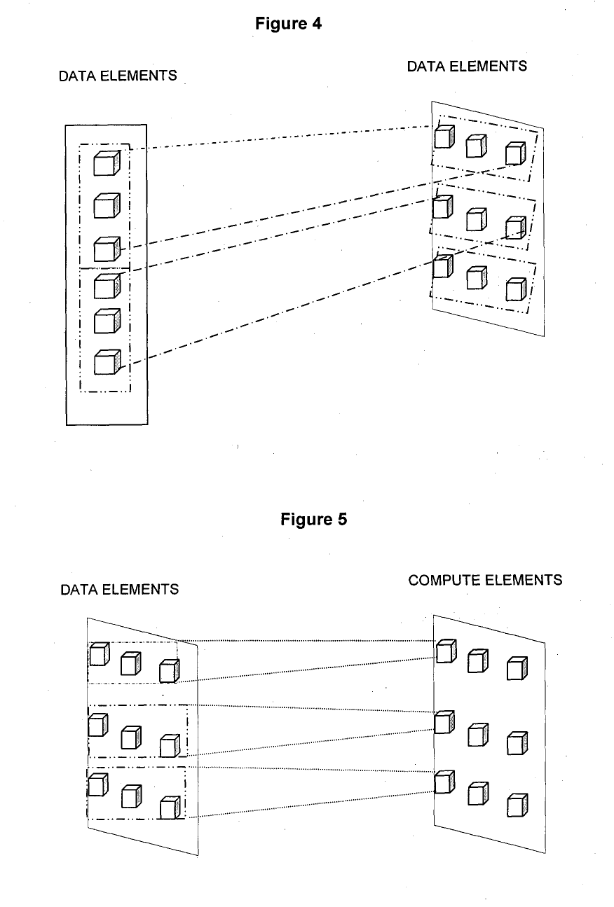

A project operation maps manifold elements to each other or to operating environment elements and is performed every frame or sub-frame. The mapping occurs when all the required resources are available. This operation can create and destroy runners and channels dynamically as required. FIG. 4 shows the projection of data elements to data elements. This can happen for example when a set of one-dimensional data elements are converted to a two-dimensional plane of data elements. FIG. 5 shows the projection of data elements onto a plane of compute elements. An example of this projection would be to multiply two matrices by mapping the matrix values to different compute elements which perform a matrix-vector multiplication. The project operation also maps manifold elements to runners. A runner is a library component which instantiates system elements and schedules them for execution. When mapping manifold elements to runners, one important optimization that is done is to send signals that do not change only once. This reduces the amount of information transferred over the system and results in speed-up. For example, when multiplying a matrix with a set of row-vectors one after the other, the complete matrix is sent to the runner only once since it does not change.

The compute, learn and transduce operations result in computations, learning and conversion to be performed.

All these operations happen in parallel across the multitude of manifold planes of a manifold frame. Each manifold operation has a requestor element which initiates the operation and a performer element which performs the operation. It is important to note that the progression of a manifold system from frame to frame happens in manifold time—that is, each element progresses at its own rate. This leads to the concept of a time path which has the manifold system time at the top and includes the time of each element in a composite manifold element until a single manifold element is reached. This time path can be represented as t1.t2.t3 . . . tn where t1 is the manifold system time and to is the time at a single manifold element. So, one unit of time at the manifold system level could be equivalent to many units of time at the manifold element level. The frame width or the time between two successive frames of a manifold system is determined by the maximum of all the time paths within a manifold system. A manifold system has no definite beginning or end. It can start and stop as required and variably progress for specific units of manifold time every time it runs. The amount of progression can be specified using the jump frequency parameter in the system configuration model. A manifold system can also be advanced to resume progression from a specific earth date. This can be controlled using the jump distance parameter in the configuration model.

Manifold system and its operations at an operating environment along with the detailed explanation of the above said method 600 according to one exemplary embodiment of the invention are as follows:

### Manifold System Modeling

The present invention proposes programming language constructs for specifying interface and behavior of compute, cognitive and transducer elements as defined in the step 610, for specifying manifold planes as defined in the step 620, for specifying relationships between various manifold elements and for modeling projections of manifold planes onto other manifold planes as defined in the step 630.

The compute, cognitive and transducer elements of a manifold system are modeled using progressive declarations, which specify behavior and interface of the dimensioned entity. A computational manifold is modeled as multiple planes of heterogeneous compute, cognitive and transducer elements. The relationships between manifold elements are specified using transitive elements. These relationships can be static or dynamic in nature. The projections of data elements to data elements are specified using transformation functions. The projections of data elements to compute, cognitive and transducer elements are specified using play statements.

Also, the present invention describes a programming language which supports modeling of dimensioned entities such as compute elements, cognitive elements, transducer elements, transitive elements, data elements, modeling multiple planes of manifold elements and modeling the projection of one plane of manifold elements onto another plane of manifold elements. The features of the programming language are described below.

The progressive keyword allows a compute or cognitive element to be modeled with an interface and behavior. The interface specifies the input and output signals of the element. A progressive declaration can be qualified with the keywords hard or soft to specify a hard progressive or soft progressive respectively.

The sensor, activator, sensor activator modifiers specify whether a signal is an input, output or both input and output to a progressive.

An input or input-output signal of a progressive can be further qualified with the learn keyword to specify that the signal is used to infer a mapping between the input and output of the progressive. A progressive with at least one signal that is qualified with learn keyword is a cognitive element.

The temporal and spatial keywords are applied to the declaration of signals that are part of the interface of a progressive. These keywords indicate that the signal is temporal or spatial in nature.

The transitive keyword is used to declare a transitive as an aggregate type consisting of signals that are inputs or outputs to ports or compute elements. Each signal declared in a transitive is of a specific type.

A manifold declaration allows the declaration of a manifold system as a set of compute elements, their interconnections and a set of interfaces for interacting with the components of the system.

A net declaration specifies the static and dynamic interconnections between the compute elements of a system. The output of a compute element is connected to the input of other compute elements to create a network.

A map statement maps the output of a compute element component to a scalar object.

A vmap statement dynamically maps the output from a vector of 1 or more compute element components to another vector.

A vstream statement dynamically streams the elements of a vector to a temporal input of a compute element.

An edge declaration specifies an interface between the compute elements of a system and the outside environment. An edge declaration consists of a set of input signals and a set of output signals. An edge declaration can include play statements to map the data elements corresponding to the problem space to the computational space represented by the compute elements defined in the system.

The index operators R0, R1 etc create a slice of the N-dimensional data element space or compute element space. R0 refers to the first dimension of the vector, R1 to the second dimension and so on. The operators can be used in the vmap, vstream and play statements.

A channel declaration allows a set of compute element declarations and manifold system definitions to be grouped under a name.

A model statement allows processor architectural models, operator models or space-time models to be declared in a program.

### EXAMPLES

### Example 1

A program which shows the use of the extensions described above. The program declares a channel named U. Within the channel, two transitive elements rin and rout are defined. The model statement specifies that st_ops is a namespace consisting of space-time operator mappings defined in the space-time model file fm_st.md.

A hard progressive muladd is declared with an interface consisting of two sensor inputs x and y and one sensor-activator z. The progressive block east defined inside muladd uses the st_ops model to specify the computations performed on the inputs x, y and z. The inputs x and y are declared as temporal indicating that they are a stream of values that is accessed over time. The progressive block core specifies that the mul operation defined in st_ops is invoked with x and y as its inputs and the result is assigned to t. The value t and z are then passed to the add operation defined in st_ops and the result is assigned to z.

The soft progressive dotp is declared with an interface consisting of two transitive objects p and o and an integer n. A progressive block named core is declared, which contains a loop to multiply and add the elements of the x and y vectors of p. The result of this operation is finally assigned to the z object declared in the transitive object o.

Another progressive sum is declared with an interface consisting of a temporal sensor input x and a sensor-activator a. The progressive block core defined inside sum uses the st_ops model to specify the computations performed on the inputs x and a. The progressive block core specifies that the add operation defined in st_ops is invoked with x and a as its inputs and the result is assigned to a.

A manifold system dotp_manifold is defined to model a manifold system. The manifold consists of a 100 element vector vp1 of type progressive muladd, a compute element vs1 of type progressive sum and compute element dp of type progressive dotp.

A net madd declares the relationships between the components of the manifold system.

The vmap statement declared in madd dynamically maps the output z of the elements of the compute element vector vp1 to a products vector. The [R0] index operator specifies that the mapping is performed for each output of the stream of 100 output values from the vector vp1.

The vstream statement declared in madd maps each element in the products vector to the input x of the compute element vs1.

The map statement declared in madd maps the output a of the compute element vs1 to an object named accumulator.

The edge dot_product is declared with an interface consisting of two input vectors x and y, an integer n and an output z of type integer. The edge declares a play statement that projects the data manifold consisting of the input vectors onto the computational manifold represented by vp1. The index n to the play statement specifies that the problem vectors are mapped to an n-element vector of compute elements.

The edge big_dot_product is declared with an interface that is identical to that of the edge dot_product. However, this edge declares that the problem space is split into n/BDWORKSIZE chunks and these are projected to BDWORKSIZE elements of the compute element vector vp1. The dot products computed by this projection are stored in a temporary vector bigz. The second play statement in big_dot_product projects the data in the vector bigz to the compute element vs1 compute the sum of all the values in the vector bigz. The output of this computation is assigned to the value z.

The edge tele_dot_product is declared with an interface consisting of two input vectors x and y, an integer n and an output z of type integer. This edge declares two transitive objects ri1 and ro1 and maps them to the inputs and outputs of the edge respectively. The edge declares a play statement that projects the data manifold consisting of the transitive objects onto the computational manifold represented by dp whose interface and behavior is specified by the progressive dotp.

```
Program:
channel U {
  transitive rin { int x[10]; int y[10]; };
  transitive rout { int z; };
  model st_ops(fm_st.md);
  progressive hard muladd (sensor temporal int x, sensor temporal int y,
sensor activator int z)
  {
    east(x, y, z)
    {
      using = st_ops::add st_ops::mul play(z, x, y)[ ];
    }
  }
  progressive soft dotp(sensor rin p, activator rout o, int n)
  {
    east(p,o,n)
    {
      using = play(o.z,0)[ ];
      using = + * play(o.z, p.x[ ], p.y[ ])[n];
    }
  }
  progressive hard sum (sensor temporal int x, sensor activator temporal
  int a)
  {
    east (x,a)
    {
      using = st_ops::add(a, x, a)[ ];
    }
  }
};
channel U {
  system dotp_manifold {
    U::muladd vp1[100];
    U::sum vs1;
    U::dotp dp;
    int products[100];
    int accumulator;
    // Declare dynamic relations between components of the system
    net madd( )
    {
          vmap (vp1, 1, 100) { vp1[R0].z products[R0]; }
        vstream (products, 1, 100) { products[R0] vs1.x; };
        map vs1.a accumulator;
    }
    edge dot_product(int x[ ], int y[ ], int n, activator int z) {
            using vp1 east play(x, y, z)[n];
    };
#define BDWORKSIZE 1000000
    edge big_dot_product(int x[ ], int y[ ], int n, activator int z)
    {
            int bigz[n/BDWORKSIZE];
            using vp1 east play(x, y, bigz)[n/BDWORKSIZE,
            BDWORKSIZE];
      using vs1 east play(bigz, z)[n/BDWORKSIZE];
    }
    edge tele_dot_product(int x[ ], int y[ ], int n, activator int z)
    {
      transitive U::rin ri1 = { x, y } ;
      transitive U::rout ro1 = { z };
      using dp east play(ri1, ro1,n);
    }
  };
};
```

### Example 2

A sample C program which makes use of the manifold system defined in the program of example 1 to compute vector dot product. A manifold system component cf1 of type dotp_manifold is declared. In the main( )function, first the input vectors x and y are initialized. Then the different ports of the dotp_manifold system are invoked to map the data manifold into the computational manifold to compute the dot product of the input vectors.

```
Sample C program:
/* Include required header files */
int x[10], y[10], z;
U::dotp_manifold cf1;
#define BIGDATASIZE 100000000
int bigx[BIGDATASIZE], bigy[BIGDATASIZE];
main( )
{
  /* Initialize input vectors x and y - Code not shown */
  /* Simple dot product */
  cf1.dot_product(x, y, 10, z);
  printf (″%x\n, z);
  /* Large dot product in parallel parts */
  cf1.big_dot_product(bigx, bigy, BIGDATASIZE, z);
  printf (″%x\n, z);
  /* 1-shot A dot-product */
  cf1.tele_product(x, y, 10, z);
  printf (″%x\n, ro1.z);
}
```

### Example 3

A program described using the below language to model matrix multiplication may also be considered. The program declares a channel MM in which two progressives MultiplyMC and matrix_mul are defined. The Multipl yMC progressive takes a matrix m1 and a column vector as inputs and a product vector as output. The east block of the progressive declares a using statement to initialize all the elements of the product vector to zero. Another using statement is declared to multiply each row of m1 with the column vector m2 and to store the resulting row in the product vector. A transitive m2d is declared with a two dimensional array m as its member.

The progressive matrix_mul describes a compute element which takes two transitives m1, m2 of type m2d as input and has a transitive product as output. The east block of the progressive declares an array RowMul of type MultiplyMC. The using statement in this block models the projection of matrix m1.m and the slice m2.m to the array of compute elements RowMul.

The system manifold MM_manifold declares a plane of compute elements mm1 of type matrix_mul. An edge single frame is declared which accepts three strings as input. These strings m1s and m2s specify the names of files from which the input matrices have to be formed and m3s specifies the name of a file to which the output matrix should be saved. A transitive m1 of type mat2d is declared with its member m assigned to the output of a form operation which takes m1s as input. The form operation is a library function which takes a file name as input and returns a two dimensional matrix. Similarly, a transitive object m3d is declared. The using statement projects the data elements onto the compute plane specified by mm1. Here, the second matrix is formed by directly invoking form with m2s as its input. This shows another way of forming a data manifold.

The multiframe edge is similar to singleframe but shows how matrix multiplication can be performed for multiple frames. The transitive objects m1, m2 and m3 specify that the matrix multiplication should progress for 100 frames with a new matrix being loaded into m1, m2 and m3 for each frame.

```
Program:
channel MM {
progressive soft MultiplyMC( int m1[ ][ ], int m2[ ], activator int
product[ ])
{
    east( ) {
      using = play(product[R0],0)  [ ];
      using += * play(product[R0], m1[R0][R1], m2[R1]) [ ][ ];
    }
  }
  transitive mat2d { int m[ ][ ] };
  progressive soft matrix_mul( in mat2d m1, in mat2d m2,
  activator mat2d product)
{
    east( ) {
      MultiplyMC RowMul[MAX_MUL];
      using RowMul.east play(m1.m, m2.m[ ][R0], product.m[ ]
      [R0]) [ ];
    }
}
  system MM_manifold {
    matrix_mul mm1;
    edge singleframe (char *m1s, char *m2s, char *m3s) {
      mat2d m1 { m = form(m1s) };
      mat2d m3 { m = form(m3s) };
      using mm1 east play( m1, form(m2s), m3 );
    }
    edge multiframe ( ) {
      mat2d m1 { m = form(″m1.plane″) [100] };
      mat2d m2 { m = form(″m2.plane″) [100] };
      mat2d m3 { m = form(″m3.plane″) [100] };
      using mm1 east play( m1, m2, m3);
}
  }
}
```

### Manifold System Synthesis

The method 600 according to the present invention accepts as input a set of models representing the elements of a manifold system at different levels of abstractions and progressively refines this set using a sequence of transformations to realize the manifold system as a combination of hardware and software elements.

The compute, cognitive and transducer elements of the manifold system may be realized as components encapsulating algebraic, procedural logic expressed in languages like C, C++, etc or as components encapsulating hardware logic expressed at Register Transfer Level (RTL) abstraction using hardware description languages like VHDL, verilog, SystemC, etc or as components encapsulating quantum logic. The RTL description may be further synthesized to gate-level and transistor-level descriptions. The transistor level description may be transformed to semiconductor mask using Standard-cells or P-Cell technologies.

The transitive elements may be realized using a transport or application layer network or as software components in a simulated system or as hardware components. A static and dynamic schedule for projecting data elements to data elements, data elements to computational manifold, computational elements to runners are also synthesized.

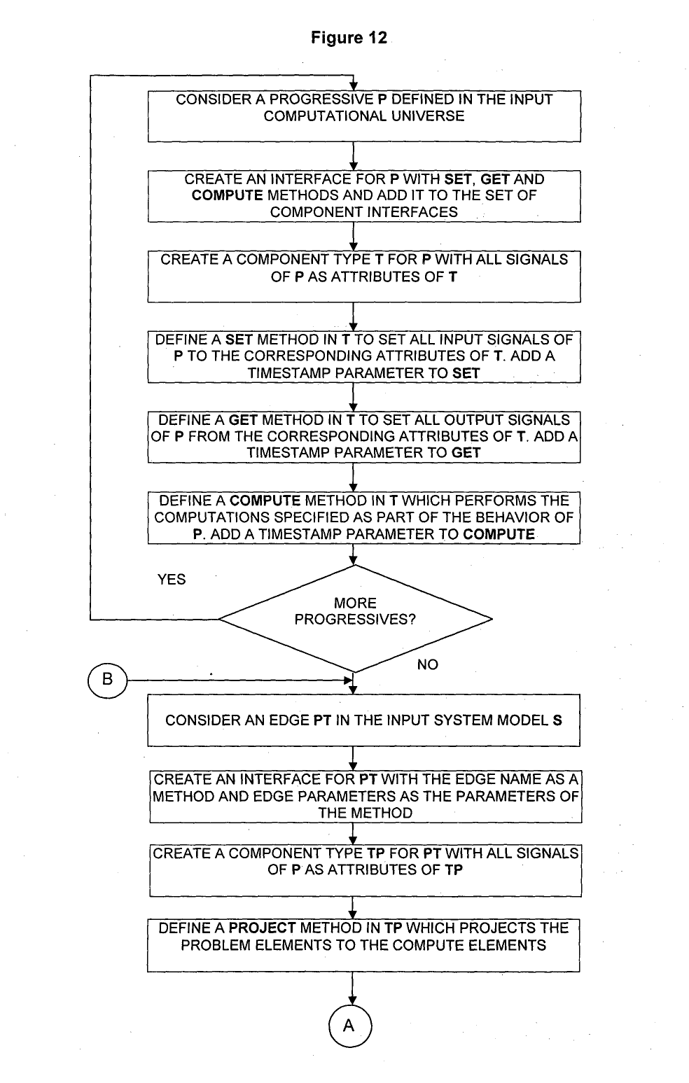

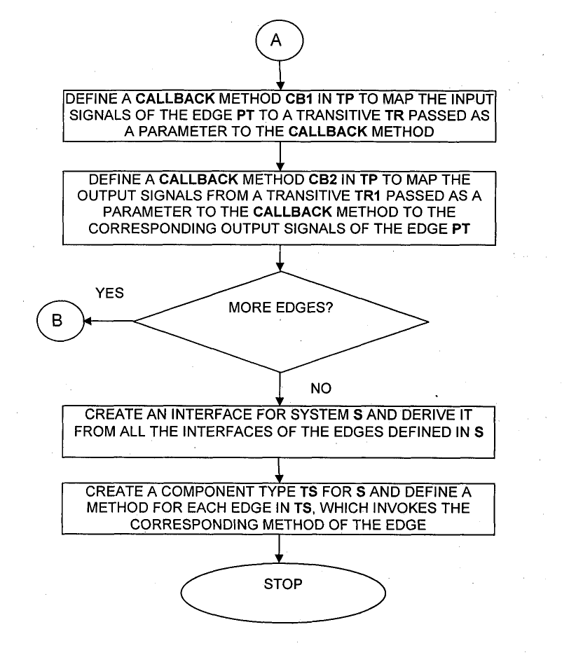

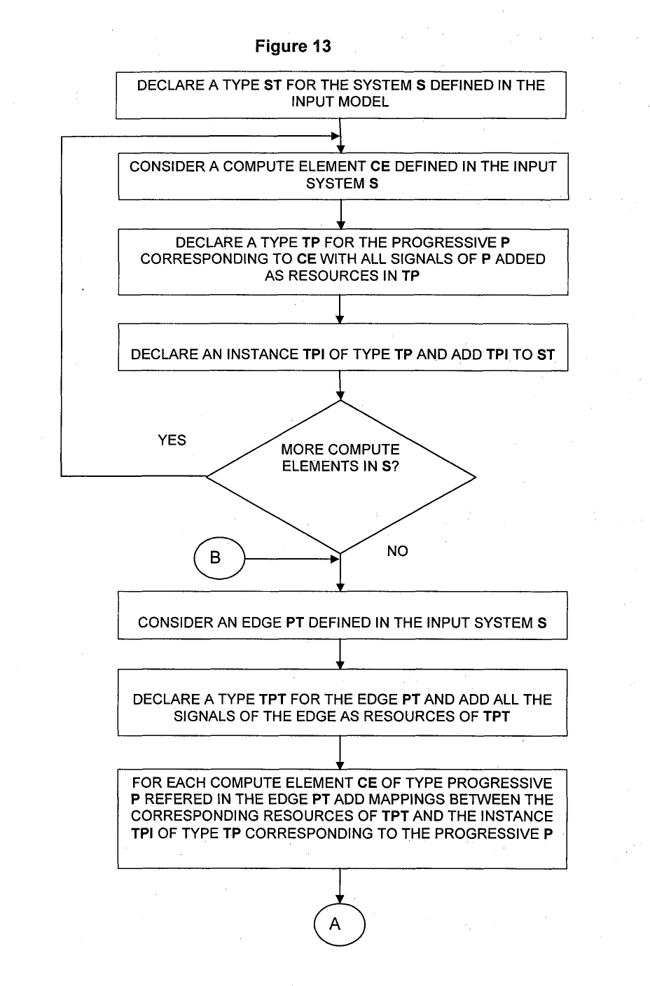

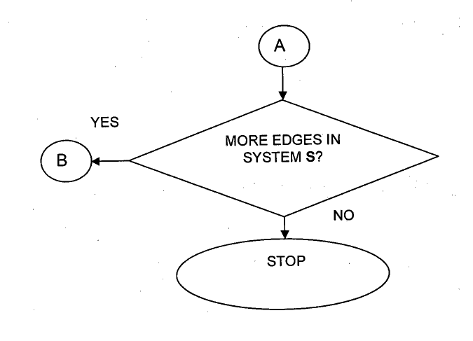

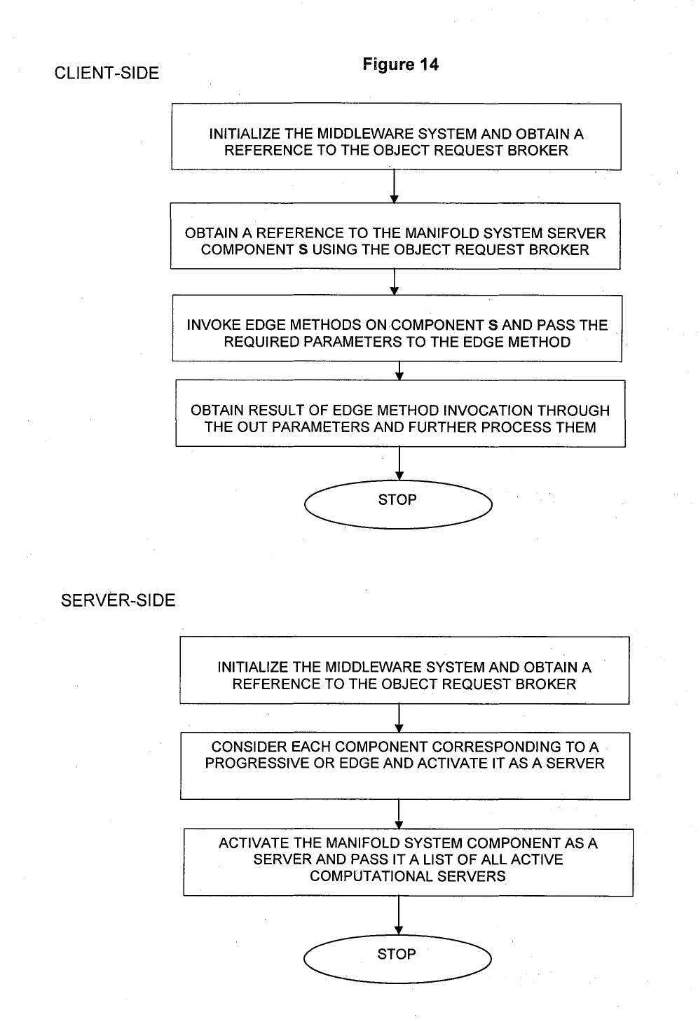

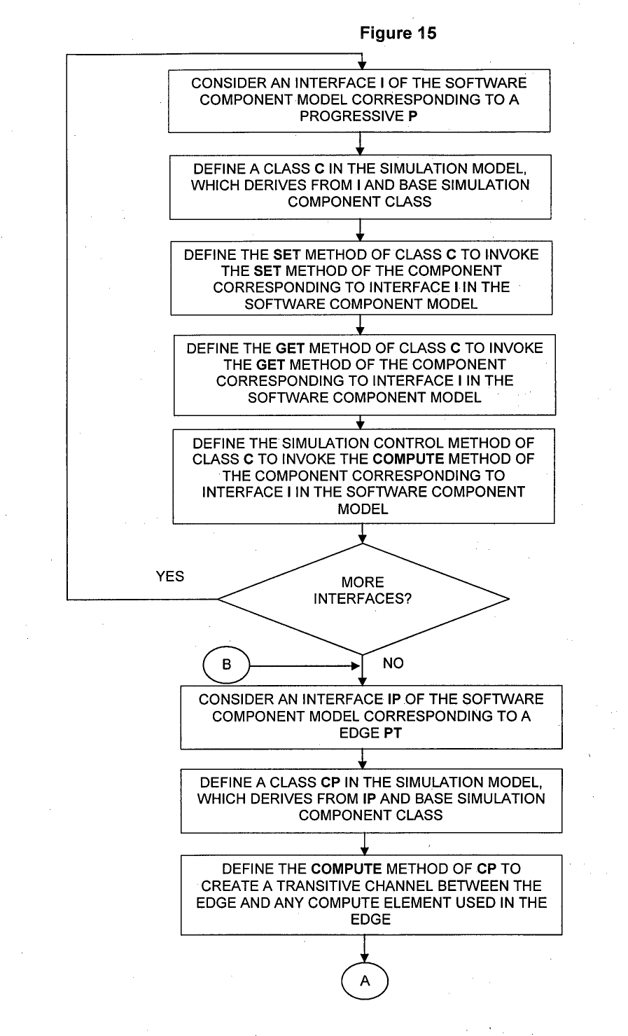

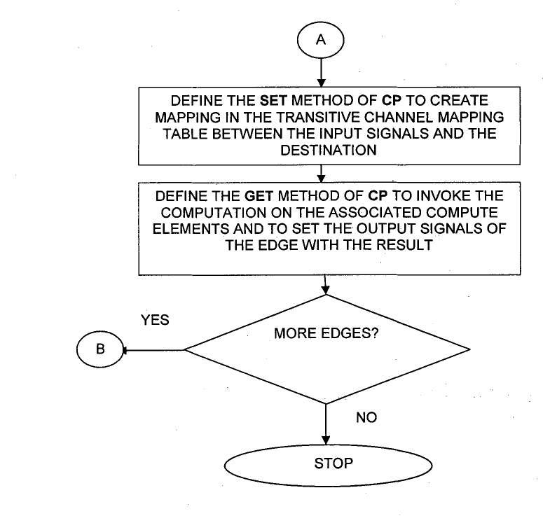

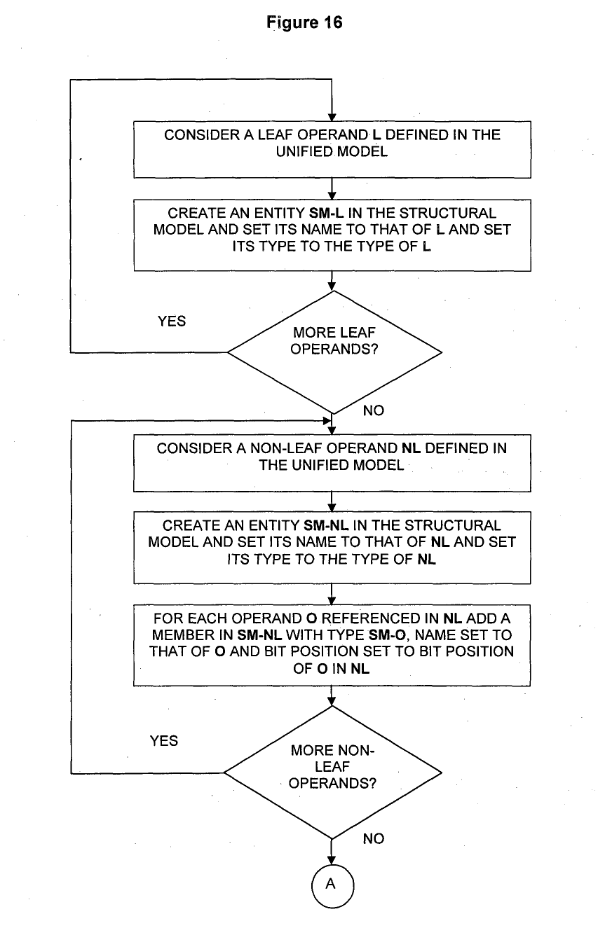

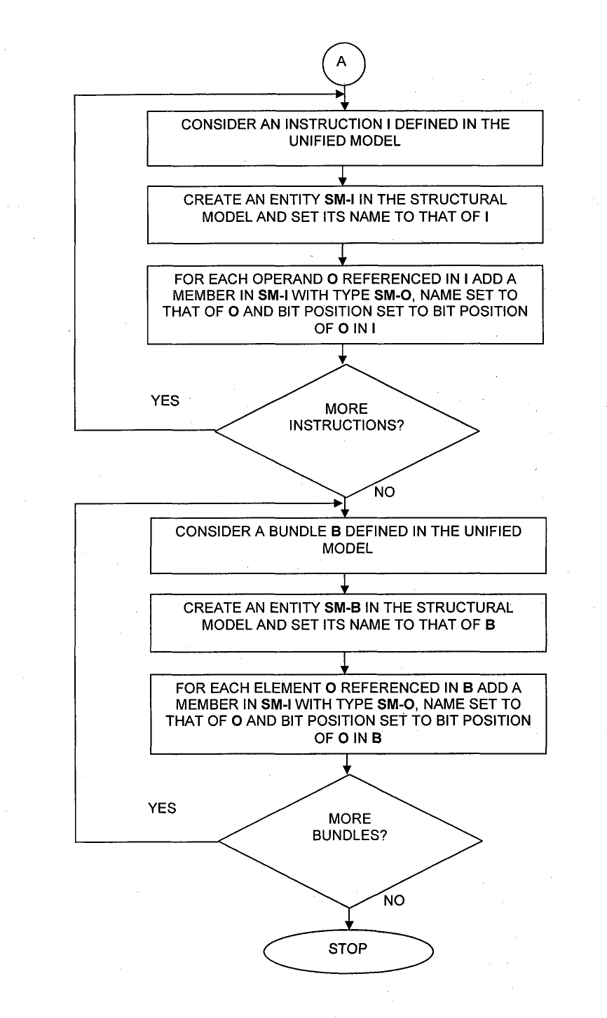

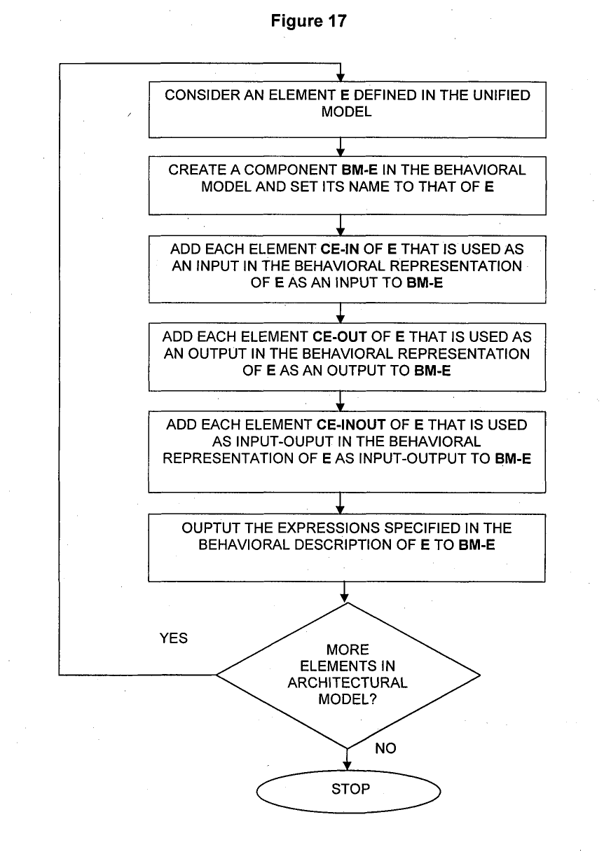

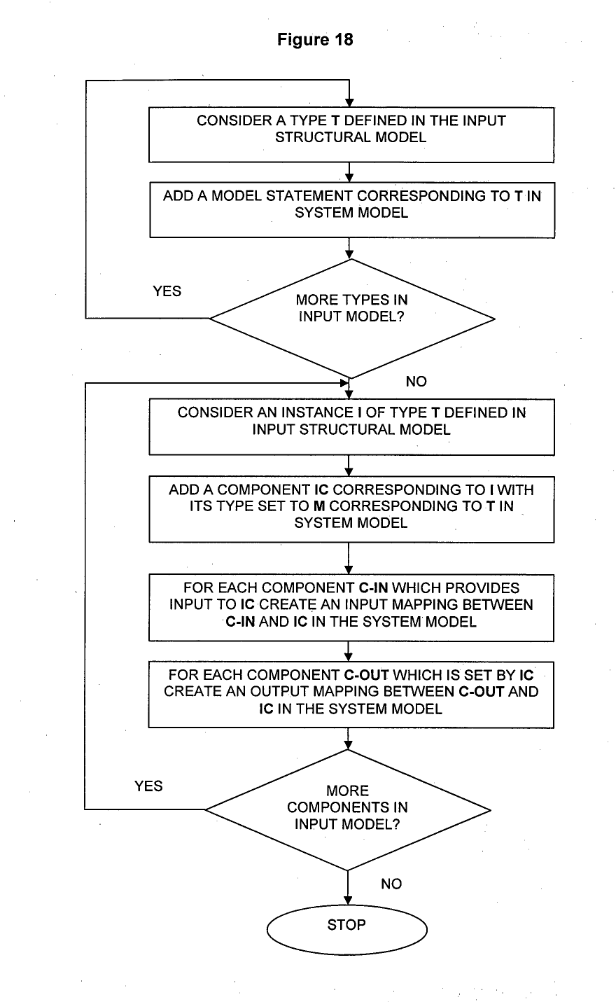

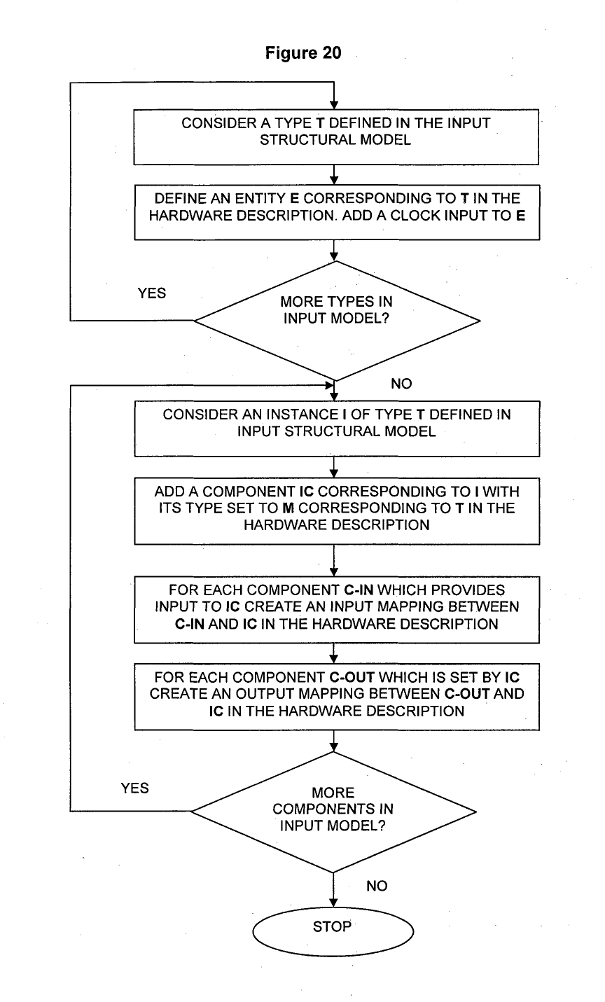

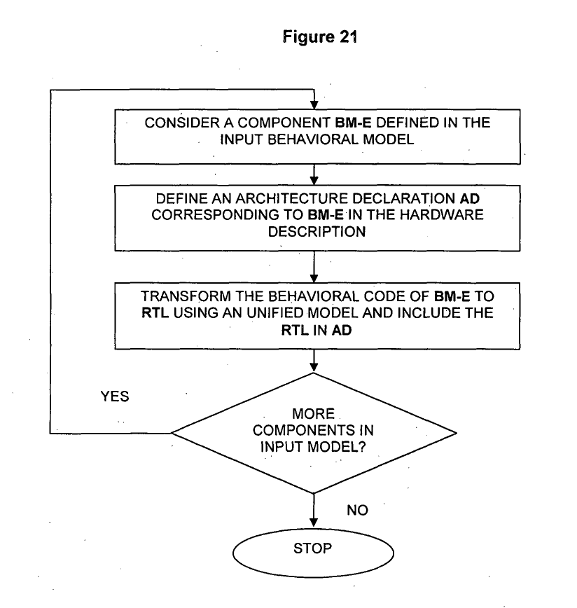

The table below shows the input model type, transformations and the output model type of the synthesis process.

| Input Model Type | Output Model Type | Description |
|---|---|---|
| High-level Description | C/C++ Component Model | Manifold Element Behavior |
| | | Synthesis (C/C++) (as shown in |
| | | FIG. 12) |
| High-level Description | Intermediate Level | Structure Synthesis (as shown in |
| | Description (Structure) | FIG. 13) |
| C/C++ Component | Distributed Component | Manifold Element Behavior |
| Model | Model | Synthesis (Distributed System) (as |
| | | shown in FIG. 14) |
| C/C++ Component | Simulation Model | Compute Element Behavior |
| Model | | Synthesis (Simulation) (as shown in |
| | | FIG. 15) |
| Processor Architectural | Intermediate Level | Processor Structure Synthesis (as |
| Model | Description (Structure) | shown in FIG. 16) |
| Processor Architectural | Intermediate Level | Processor Behavior Synthesis (as |
| Model | Description (Behavior) | shown in FIG. 17) |
| Space-time Model | Intermediate Level | Space-Time Behavior Synthesis a |
| | Description (Behavior) | shown in FIG. 17) |
| Intermediate Level | Simulation Model | Structure Synthesis (Simulation) (as |
| Description (Structure) | (Structure) | shown in FIG. 18) |
| Intermediate Level | Register Transfer Language | Structure Synthesis (Hardware) (as |
| Description (Structure) | (RTL) Description | shown in FIG. 20) |
| | (Structure) | |
| Intermediate Level | Distributed Component | Structure Synthesis (Distributed |
| Description (Structure) | Model (Structure) | System) |
| Intermediate Level | Simulation Model | Processor Behavior Synthesis |
| Description (Behavior) | (Behavior) | (Simulation) (as shown in FIG. |
| | | 19) |
| Intermediate Level | RTL Description (Behavior) | Processor Behavior Synthesis |
| Description (Behavior) | | (Hardware) (as shown in FIG. 21) |
| C Program | Intermediate Level | Compilation |
| | Description (Behavior) | |
| Intermediate Level | Assembly Code | Assembly code generation |
| Description (Behavior) | | |
| Assembly Code | Machine Code | Machine code generation |
| RTL Description | Gate-level Description | Gate-level Hardware Description |
| Gate-level Description | Transistor-level Description | Transistor-level Hardware |
| | | Description |
| Transistor-level | Integrated Circuit Layout | Integrated Circuit Layout |
| Description | | Description using Standard Cell or |
| | | PCell |
| IntermediateLevel | Hardware Abstraction | Hardware Abstraction Layer library |
| Description | Layer | |
| Intermediate Level | Processor Abstraction Layer | Processor Abstraction Layer library |
| Description | | |
| Processor Architectural | Test Description | Processor Verification Synthesis |
| Model | | |

### Multi-ladder (Synthesis) Approach

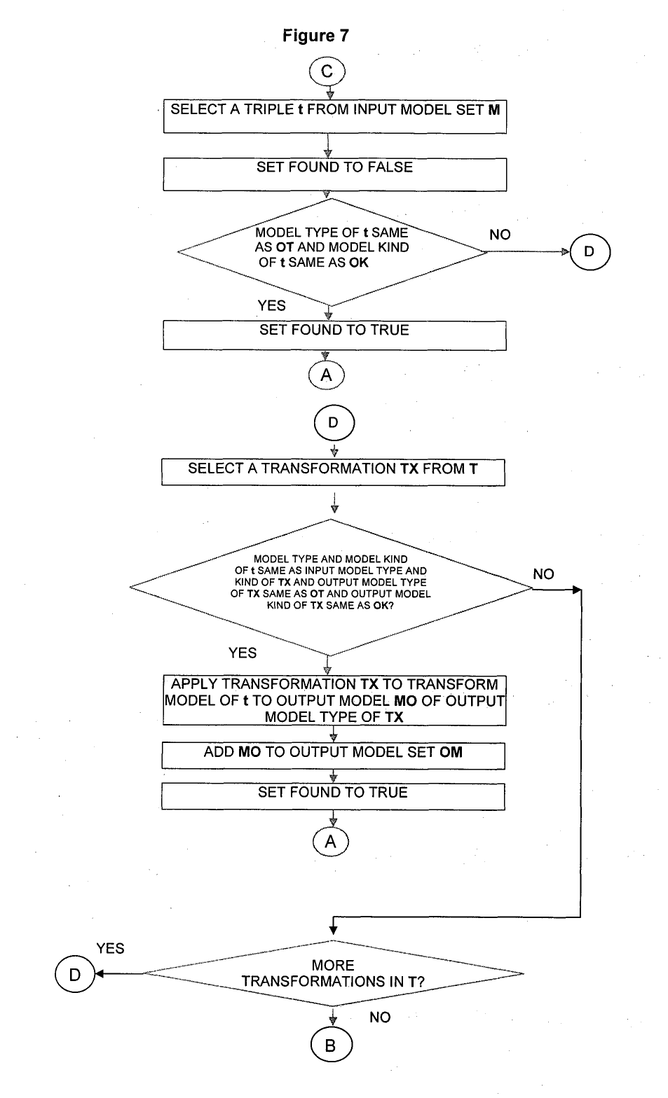

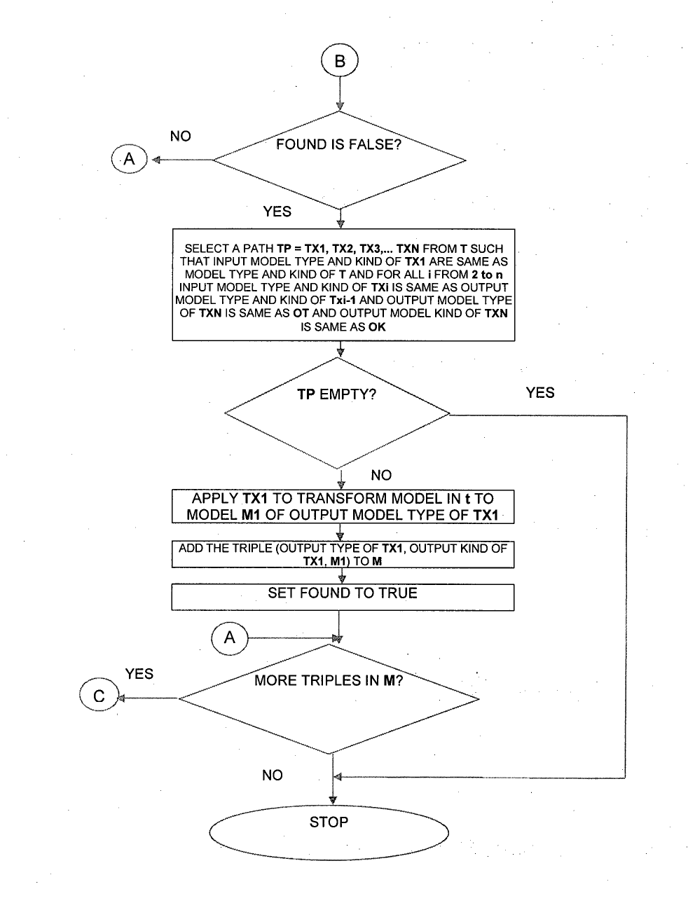

According to one exemplary embodiment of the invention, the multi-ladder synthesis process (as shown in FIG. 7) transforms input models that describe a manifold system structure and behavior to models at different levels of refinement as defined in the step 640, wherein the manifold system components are described using algebraic, procedural, boolean, quantum or transistor logic, etc using a sequence of steps.

The inputs to the multi-ladder synthesis step are as follows:

Input: Set of model triples M consisting of (model type, model kind, model), where model type specifies the language used for abstraction, the model kind specifies what is abstracted (for example, software, hardware or network) and model is the abstracted entity

Input: Set of transformations T where each member is a transformation which transforms an input model m1 of model type t1 and model kind k1 to an output model m2 with model type t2 and model kind k2.

```
Input: Required output model type ot and model kind ok.
Output: Set OM consisting of transformed models
Steps
for each triple t in M
  if model type of t is the same as ot continue
  else
    set found to false
    for each transformation tx in T
      if input model type of tx is same as model type of t and
        input model kind of tx is same as model kind of t and
        output model type of tx is same as ot and
        output model kind of tx is same as ok then
        apply transformation tx to transform model of t to output model
        mo of model type and model kind of tx
        add mo to the output model set OM
        set found to true
        break
    end for
    if found is false then
        select a path tp = tx1, tx2,..., txn from T such that
            input model type of tx1 is same as input model type
            of t and
            input model kind of tx1 is same as input model kind
            of t and
            for all i from 2 to n
              input model type of txi is same as output model type of
              txi-1 and
              input model kind of txi is same as output model kind of
              txi-1 and
            output model type of txn is same as ot and
            output model kind of txn is same as ok
      if tp is not empty
          apply tx1 to transform the model in t to model m1 of output
          model type of tx1
          add the triple (output model type of tx1, output model kind
          of tx1, m1) to M
          set found to true
      end if
  end if
  if found is false then stop as no transformation is available
  end if
end for
```

### Synthesis to Software Models for Distributed Computing

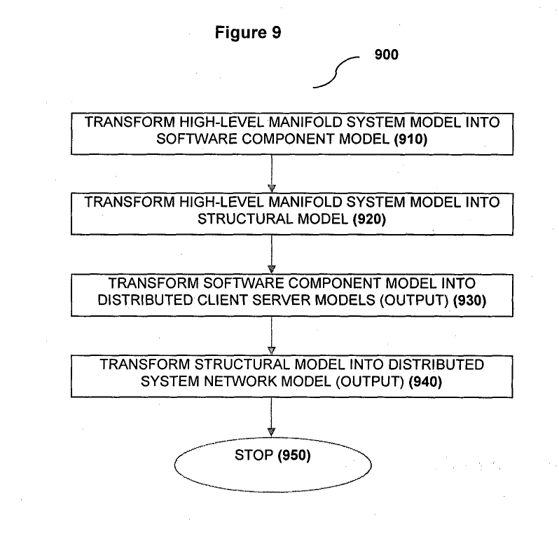

FIG. 9 shows the steps of the method 900 according to the present invention for transforming a high-level manifold system model to software models for distributed computing.

In the initial step 910, the high-level manifold system models described using the programming languages are transformed into a software component model as shown in FIG. 12. In FIG. 12, initially an interface is created for each progressive P which is used in the system. The interface includes SET, GET and COMPUTE operations. Each of these operations accepts a timestamp as a parameter. This timestamp is used across a manifold system to enforce an ordering on the manifold operations that occur simultaneously across the system. A component type T which derives from the said interface is then defined. This type T includes all the signals of P as attributes. The SET method of T is defined to set all the attributes of T corresponding to input signals of P. The GET method of T is defined to set all the output signals from the corresponding attributes of T. The COMPUTE method of T is defined to perform the computation specified as part of the behavior of P. Next, each edge PT in the input system S is considered. An interface is defined for PT with the edge name as a method and edge parameters as the parameters of the method. A component type TP is created for the edge PT with all signals of p as attributes of TP. A PROJECT method is defined in TP to project the data elements to the compute elements. A callback method cb1 is defined in TP to map the input signals of the edge PT to a transitive component TR passed as a parameter to the callback method. A callback method cb2 is defined in TP to map the output signals from a transitive component TR1 passed as a parameter to the callback method to the corresponding output signals of the edge PT. Next, an interface for system s is created, which derives from all the interfaces of the ports defined in S. Finally, a component type TS is defined for S and a method is defined for each edge in TS, which invokes the corresponding method of the edge.

In the next step 920, as shown in FIG. 13, the high-level manifold system model is transformed into a structural model. Initially, a type ST is declared in the structural model corresponding to the system S defined in the input model. Then for each compute element CE defined in S, a type TP is declared corresponding to the progressive P corresponding to CE with all signals of P added as resources of TP. Next, an instance TPI of TP is defined and added to ST. Then for each edge PT defined in S, a type TPT is declared in ST and all the signals of PT are added as resources of TPT. Finally, for each compute element CE of type progressive P referred in the edge PT mappings between the corresponding resources of TPT and the instance TPI of type TP corresponding to the progressive P are added to ST.

In the next steps 930 and 940, as shown in FIG. 14, the software component models of a manifold system are transformed into client-server models for distributed computing. Initially, on the client-side the distributed computing middleware system is initialized and a reference to the object request broker is obtained. Then a reference to the manifold system server component S is obtained using the object request broker. The edge methods of the server component S are invoked with the required parameters. Finally, the results of edge method invocation are obtained through the out parameters and these results are further processed as required. On the server-side, initially, the distributed computing middleware system is initialized and a reference to the object request broker is obtained. Next, each component corresponding to a progressive or an edge is activated as a server on available computing systems. Finally, the manifold system component is activated as a server and the list of all active computational servers are passed to the server so that client requests can be forwarded to appropriate computational servers.

The method 900 ends in a step 950.

### Synthesis to Software Models for System Simulation

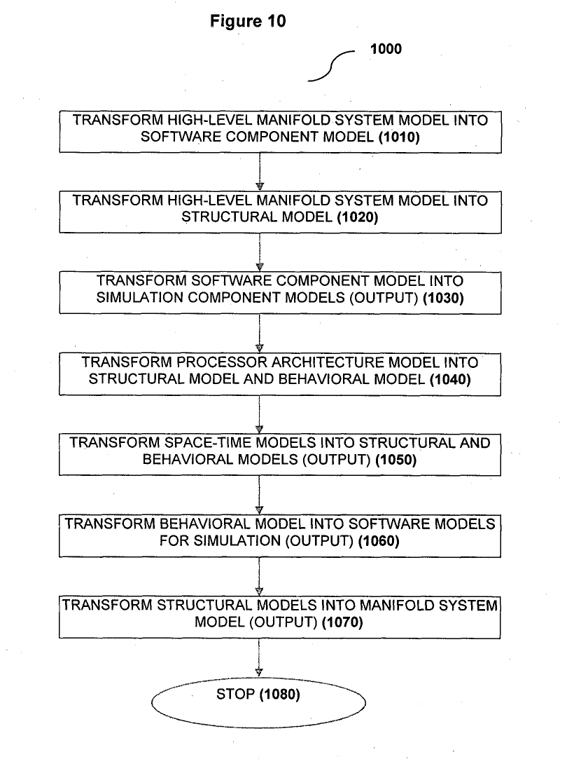

FIG. 10 shows the steps of a method 1000 for transforming a high-level manifold system model to software models for system simulation according to one exemplary embodiment of the invention.

A system simulator is a software tool that accepts a system model as input and simulates the system so that software targeted for that system can be executed on the simulated system instead of corresponding hardware. To transform the high-level system models to simulation models, first the models are transformed to software component model (step 1010) and structural model (step 1020) as described in FIG. 12 and FIG. 13 respectively. In the next step 1030, the software component model is transformed to simulation component models as described in FIG. 15. Initially, for each interface I in the software component model, a class C is defined in the simulation model, which derives from I and a base simulation component class. The SET method of class C is defined such that it invokes the SET method of the component corresponding to interface I in the software component model. The GET method of class C is defined such that it invokes the get method of the component corresponding to interface I in the software component model. The execution control method (for example, RUN, STEP etc.) is defined such that it invokes the COMPUTE method of the component corresponding to interface I in the software component model. Next, for each interface IP of the software component model corresponding to an edge PT, class CP is defined in the simulation model, which derives from IP and a base simulation component class. The COMPUTE method of CP is defined such that it creates a transitive channel between the edge component and any compute element used in the edge component. The SET method of CP is defined to create a mapping in the transitive channel mapping table between the input signals and the destination. The GET method of CP is defined to invoke the computation on the associated compute elements and to set the output signals of the edge with the result of the computation.

In the next steps 1040 and 1050, a processor architectural model or a space-time model used in the input system is transformed into structural models as shown in FIG. 16. Initially, for each leaf operand L in the input unified model an entity SM-L is defined in the structural model and its name and type are set to that of L. Then for each non-leaf operand NL in the input unified model, an entity SM-NL is defined in the structural model with its name and type set to that of NL. For each operand O referenced in NL, a member is added in SM-NL with its type set to SM-O, name and bit-positions are set to that of O. Then for each instruction I defined in the input unified model, an entity SM-I is created in the structural model and its name is set to that of I. For each operand O referenced in I, a member is added to SM-I with name set to that of O and type set to SM-O and bit-position set to that of O. Then for each bundle B defined in the input unified model, an entity SM-B is created in the structural model and its name is set to that of B. For each element O referenced in B, a member is added to SM-B with name set to that of O and type set to SM-O and bit-position set to that of O.

An input unified model is transformed into behavioral models as shown in FIG. 17. Initially, for each element E defined in the input unified model, define a component BM-E in the behavioral model and set its name to that of E. Then, each element CE-IN of E that is used as an input in the behavioral representation of E is added as an input to BM-E. Each element CE-OUT of E that is used as an output in the behavioral representation of E is added as an output of BM-E. Each element CE-INOUT of E that is used as input-output in the behavioral representation of E is added as an input-output data of BM-E. Then, the expressions specified in the behavior al representation of E in the unified model are added to BM-E.

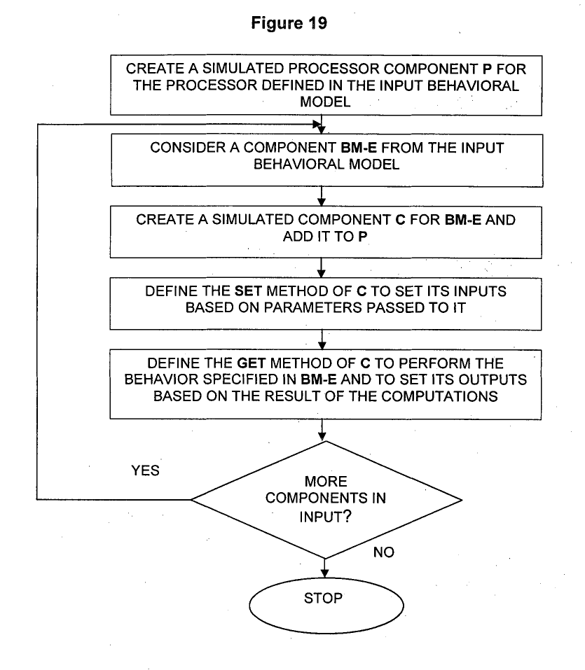

In the next step 1060, behavioral models of processors or compute elements are transformed into behavioral simulation models as shown in FIG. 19. Initially, a simulated processor component P is created for the processor element defined in the input behavioral model. For each component BM-E in the input behavioral model, a simulated component C is created and added to P. The SET method of C is defined to set its inputs based on the parameters passed to it. The GET method of C is defined to perform the behavior specified in BM-E and to set its output parameters based on the result of the computations.

In the final step 1070, structural models of processors or compute elements are transformed into simulation models as shown in FIG. 18. Initially, for each type T defined in the input structural component model, a model statement is added to the structural system model. For each instance I of type T defined in the input structural model, a component IC corresponding to I with its type set to M corresponding to T is added to the structural system model. For each component C-IN which provides input to component IC, a mapping is added between C-IN and IC in the structural system model. For each component C-OUT which accepts inputs from IC, a mapping is added between C-OUT and IC in the structural system model.

The method 1000 ends in a step 1080.

### Synthesis to Hardware Models

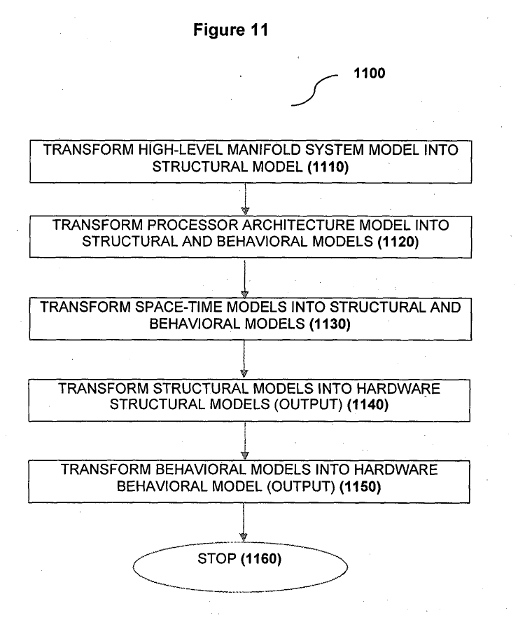

FIG. 11 shows the steps of a method 1100 for transforming a high-level manifold system model into structural and behavioral hardware models according to one exemplary embodiment of the invention.

In the initial step 1110, the high-level manifold system model is transformed into structural models as described in FIG. 12. In the next steps 1120 and 1130, any processor or space-time models are transformed to structural and behavioral models as shown in FIG. 16 and FIG. 17.

In the next step 1140, structural models are transformed into hardware structural description as shown in FIG. 20. Initially, for each type T defined in the input structural model, an entity E is added to the hardware structural model. The input and output signals of E are mapped to corresponding types in T. A clock signal is also added to E. This clock signal is used across the manifold system to enforce an ordering on the manifold operations that occur simultaneously across the system. Then, for each instance I of type T defined in the input structural model, a component IC is added to the hardware description with its type set to entity M corresponding to T. For each component C-IN which provides input to IC a mapping is created between C-IN and IC in the hardware structural model. Similarly, for each component C-OUT which accepts an output of IC, a mapping is created between IC and C-OUT in the hardware structural model.

In the final step 1150, input behavioral models are transformed into hardware behavioral description as shown in FIG. 21. In FIG. 21, initially, for each component BM-E defined in the input behavioral model, an architecture declaration AD is defined in the hardware behavioral model. Then, the behavioral expressions in BM-E are transformed to RTL using a unified grammar specification as described in U.S. Pat. No. 7,529,658 to Bulusu et al, the entire contents of which is incorporated by reference herein.

An RTL description of the elements of a manifold system can be transformed to a gate-level netlist description using a unified model according to U.S. Pat. No. 7,529,658 to Bulusu et al, the entire contents of which is incorporated by reference herein, which specifies the equivalence between RTL constructs and gate-level constructs.

Similarly, a gate-level netlist description can be transformed to a transistor-level netlist where each gate is realized using one or more transistors. For each gate in the input, such as, NAND, NOR, the equivalent transistor description can be obtained from an external unified model specified according to U.S. Pat. No. 7,529,658 to Bulusu et al, the entire contents of which is incorporated by reference herein. This can be output along with the connections to obtain the transistor-level netlist.

Finally, the transistor-level netlist can be transformed to an integrated circuit layout using standard cells or parametrized cells (or PCell).

The method 1100 ends in a step 1160.

### Sequential Behavior Synthesis

Sequential behavior described as soft progressives or as functions using a programming language like C or C++ can be compiled to machine code by applying a series of transformations on the input program. First, the input program is transformed to an intermediate-level description by using a language front-end. A series of transformations is applied to this intermediate-level description using external unified models. These transformations can split a complex expression to multiple expressions supported by the target processor, perform load-store transformations and can also optimize the input program. Finally, another transformation maps the final intermediate-level description to assembly code using the processor architectural model. An assembler program then transforms the input assembly code to machine code module using the same processor architectural model. A linker program links several machine code modules to generate an executable. This executable can then be scheduled to be loaded to a specific processor of the manifold system.

### Processor Test Sequence Synthesis

One of the outputs from the synthesis process is a set of test sequences that can be used to verify the processor elements of a manifold system. A tool such as the Model Space Explorer tool from Sankhya Technologies (http://www.sankhya.com/info/products/teraptor/verify.html#page-7) can be used to automatically generate test sequences from a processor architectural model and a verification strategy.

### Processor Abstraction Layer (PAL) Synthesis

The synthesis process according to the present invention accepts an operator model and synthesizes a set of functions for interrupt handling, cache control, TLB control, exception handling and memory management for the specified processor. The operator model specifies predefined operators for saving and restoring context, enabling, disabling and flushing the cache and TLBs, setting up segmentation registers etc. These operators are mapped to equivalent intermediate level description expressions for the given processor. The synthesis process accepts the operator model as input and generates intermediate level description. This intermediate level description can then be compiled to a PAL library. Programs targeted to the processor can use the functions from the PAL library to obtain the required processor functionality.

### Hardware Abstraction Layer (HAL) Synthesis

The Hardware Abstraction Layer forms an interface between system hardware and programs running on the system. The HAL hides the device specific details and provides a uniform interface that is independent of a specific device. The synthesis process according to the present invention allows the components of a HAL to be synthesized from system description. This includes memory mapping for each device, device initialization, system boot code etc. This information can be synthesized from the input processor models, device models and system models.

### Relationship Synthesis

A transitive is synthesized to a logical channel. The channel consists of a mapping table (as shown below) where each signal of the transitive is given a bit offset (address) and a size based on the type of signal. The start and end address of a signal are mapped to the corresponding address on the other side of channel. For the signals for which an input/output mapping function is specified in the transitive declaration in the input model, the same is specified in the mapping table.

| Source | Source | | Input | Output |
|---|---|---|---|---|
| Address | Address | Target | Mapping | Mapping |
| Start | End | Address | Function | Function |
| S1 | E1 | T1 | IF1 | OF1 |
| S2 | E2 | T2 | — | — |
| S3 | E3 | T3 | — | — |
| . . . | . . . | . . . | | |

As shown above, source address range (S1, E1) is mapped to target address T1, (S2, E2) is mapped to T2 and so on. Also, mapping functions IF1 and OF1 are specified for the first signal in the table. When a location in the range (S1, E1), for example, is read by a compute element, the mapping function IF1 is invoked to obtain the data and make it available to the compute element. The mapping function can obtain the data from a variety of sources like databases, files, web servers etc and/or perform computations on the data before sending it to the compute element. Similarly, when the signal is updated by a compute element the mapping function OF1 is invoked to perform additional computations on the data or to send it to an output stream.

The synthesized logical channel has certain operations associated with it to allow access and modification of signals. A read operation allows a value to be read from memory, a write operation to write values to memory, a get operation to obtain data from stream and a put operation to send data to a stream.

A logical channel can be realized as a software communication library or a dedicated hardware channel. A logical channel corresponding to a temporal window transitive can be synthesized using different templates depending on whether the channel connects two hardware elements, two software elements or hardware and a software element.

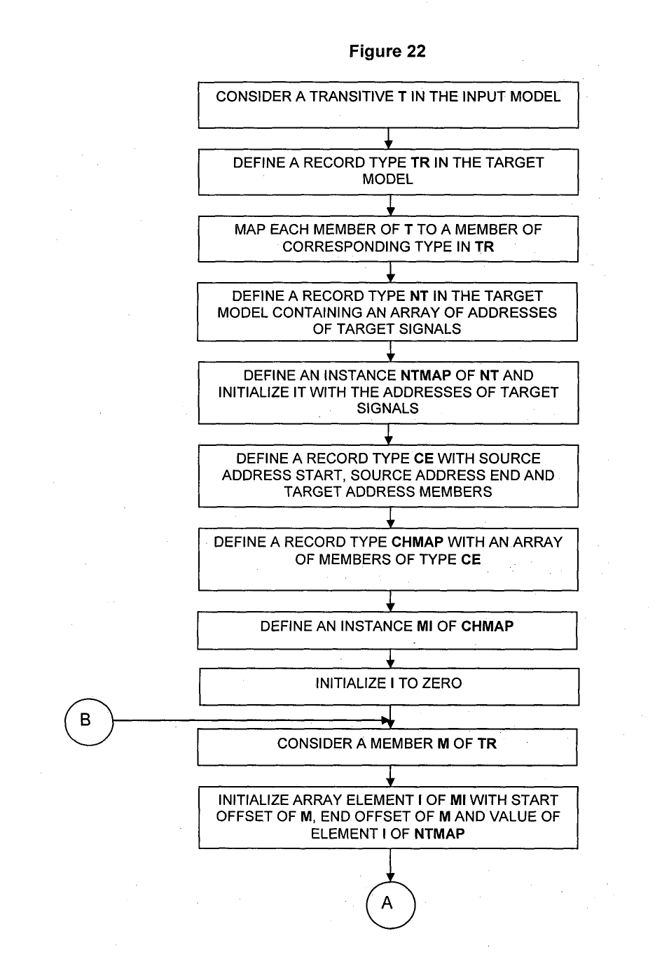

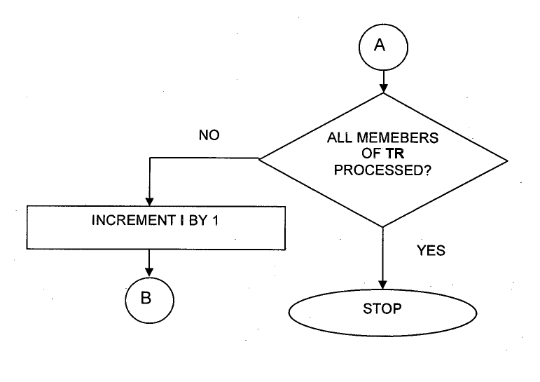

FIG. 22 shows the steps of a method for synthesizing a software channel from the model of a transitive according to one exemplary embodiment of the invention. First, a transitive T defined in the input model is considered. This is mapped to a record type TR in the target model. Each member of the transitive is mapped to a member of corresponding type in the target record type. Next, a record type NT containing an array of addresses is defined in the output model. An instance NTMAP of this record type is defined and all elements of the array are initialized to the addresses of the target signals of the transitive T. A record type CE is defined in the output model with source start address, source end address and target address fields. Another record type CHMAP is defined in the output model with an array of type CE as its member. An instance MI of type CHMAP is defined in the output model. For each field in TR an entry is defined in MI with its source start address set to starting offset of the field in TR, its source end address set to ending offset of the field in TR and its target address set to the value of the corresponding element of the array member of NTMAP.

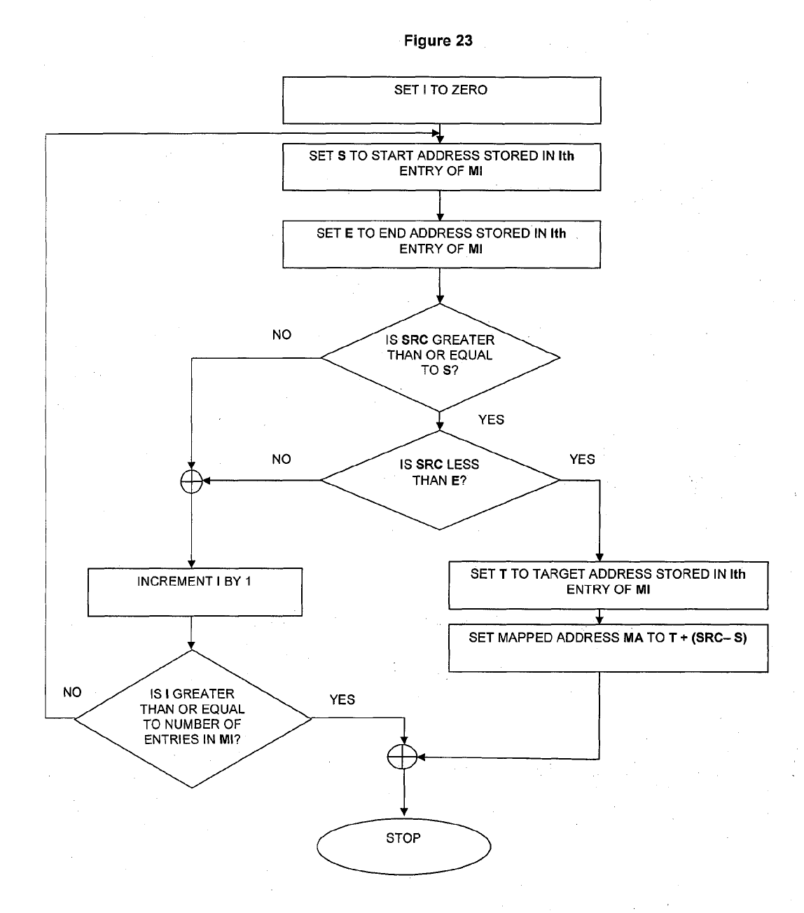

FIG. 23 shows the steps of a method for mapping a source address to a target address using a channel according to one exemplary embodiment of the invention. The method accepts a channel map instance MI and an address SRC as inputs. Each entry in MI is checked to see if the input address SRC is within the range of the start and end addresses of that entry. If it is, then the address of the Nth byte of data from the target address stored in the entry is returned, where N is the difference between SRC and the start address stored in the entry.

### Projection

In the final step 650 of the method 600, a schedule projects the problem elements to the cognitive element space of a manifold system so that the given problem is solved when the cognitive elements operate on the problem elements as per the schedule. A schedule can be static, meaning that the projection is fixed and determined a-priori. A dynamic schedule is one where the projection can change when the system is in operation.

### a) Static Projection

The compute, cognitive or transducer elements of a manifold system may be realized as hardware components or as software components. When the manifold system operates these elements should be projected to a runner so that the behavior of the compute element can be realized on a processor element that is part of the system. This mapping can be controlled by a configuration model which can specify parameters that control which compute elements are mapped to which processors, how many runners are available, the percentage of software to hardware runners to be initialized and so on. In the case of a soft progressive the compute element can be mapped to a runner component from a library. One or more runner components can then be mapped to one or more threads of the operating environment. In the case of a hard progressive, the compute element can either be mapped to a hardware runner (for example a Field-Programmable Gate Array) or it can be mapped to a software runner. A static schedule maps the initial manifold elements of a manifold system to available runners based on the configuration.

### b) Dynamic Projection

A dynamic schedule is one where the projection can change when the system is in operation. A dynamic scheduler or projector projects a plane whenever the required resources are available. Also it can create a manifold on the fly with input resources and operating environment support.

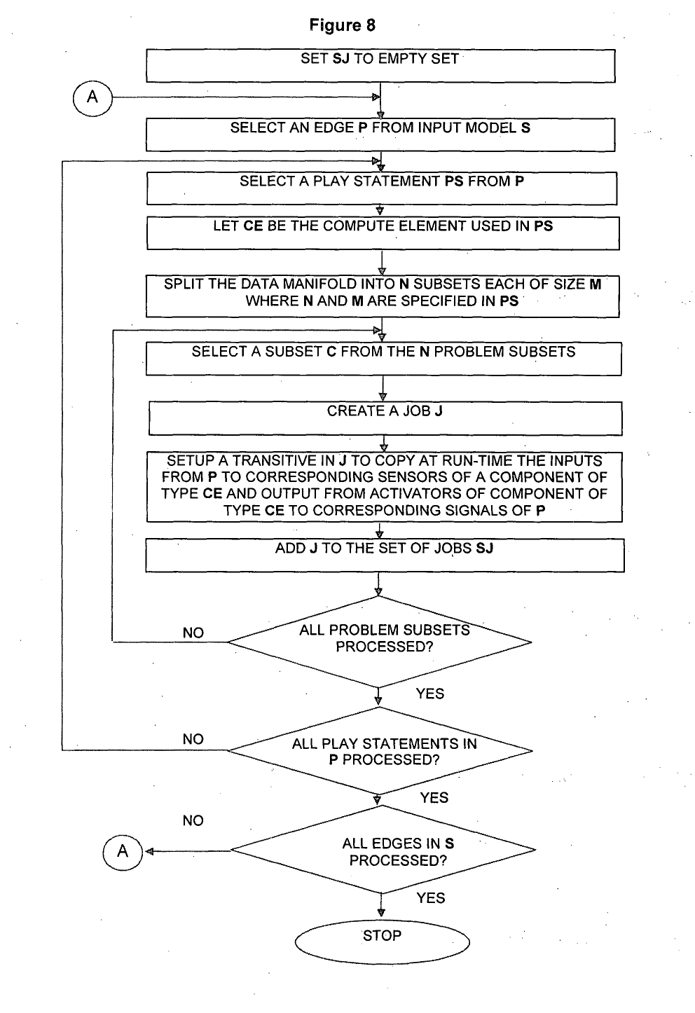

The steps (as shown in FIG. 8) involved in generating a dynamic schedule are described below:

### Inputs

1) Manifold system model specified using the language described in this invention

```
Output:
A set of jobs SJ
For each edge P in input manifold S
  For each play statement PS in P
    Let CE be the manifold element used in PS
```

| | |
|---|---|
| • | Split the input manifold element into N subsets each of |
| | size M where N and M are specified in PS |
| • | For each subset C from 1 to N |
| ∘ | Create a job J |
| ∘ | Setup a transitive in J to copy at run-time inputs from |
| | P to corresponding sensors of a component of type CE |
| | and output from activators of the component of type |
| | CE to corresponding signals of P |
| ∘ | Add J to the set of jobs SJ |

```
    End For
  End For
End For
The method 600 ends in a step 660.
```

According to another embodiment of the invention, an apparatus 100 is provided for realizing a manifold system from input models, comprising the followings such as means for modeling a computational manifold as multiple planes of compute elements conforming to behavioral models and their relationships, means for modeling a data manifold as multiple planes of problem elements, means for modeling a projection of the data manifold onto the computational manifold, means for synthesizing a manifold system of required model type and level of abstraction, and means for synthesizing a schedule which projecting the data manifold onto the computational manifold to solve a given problem.

According to another embodiment of the invention, a non-transitory computer readable medium 120 is provided for realizing a manifold system from input models, including program instructions executable by a computer for the following steps:

In the first step 610, a computational manifold is modeled as multiple planes of compute elements conforming to behavioral models and their relationships. In the next step 620 of the method, a data manifold is modeled as multiple planes of problem elements. In the next step 630, a projection of the data manifold onto the computational manifold is modeled. In the next step 640, a manifold system of required model type and level of abstraction is synthesized. In the final step 650, a schedule is synthesized which projects the data manifold onto the computational manifold to solve a given problem.

According to another embodiment of the invention, a computer program is provided, the program comprising program code stored in a non-transitory computer readable medium 120, the program code executable by a computer 110 to carry out the method 600 for realizing a manifold system from input models.

According to another embodiment of the invention, a computer program is provided, the program comprising program code stored in a non-transitory computer readable medium 120, the program code executable by a computer 110 to carry out the method 600 for realizing a manifold system from input models, the program code arranged for being integrated in or added to a computer application for joint execution of said computer program and said computer application by said computer 110.

According to another embodiment of the invention, a computer program product is provided, the product comprising program code stored on a non-transitory computer readable medium 120, the program code readable by a computer 110, which operates to carry out the method 600 for realizing a manifold system from input models, when said program code is executed by said computer 110.

According to another embodiment of the invention, a computer program product is provided, the product comprising program code stored on a non-transitory computer readable medium 120, the program code readable by a computer 110, which is operable to carry out the method 600 for realizing a manifold system from input models, and further comprising integrating said program code into a computer application for joint execution of said program code and said computer application by said computer 110.

According to another embodiment of the invention, an apparatus 100 is provided for accessing at least one temporal and spatial data from at least one source in a manifold system, comprising the followings such as means for mapping the at least one temporal and spatial data from the at least one source to signals of the compute elements using a transitive element of the manifold system, wherein i) the transitive element specifies the relationship between a) a set of data elements, b) the data elements and the compute elements, or c) the compute elements; ii) the data elements along with their sources are declared using a transitive declaration; and means for accessing the at least one temporal and spatial data from the at least one source thereby mapping a source address to a target address using a channel by: i) accepting a channel map instance and an address as inputs; ii) for each entry in the channel map instance, checking whether the input address is within the range of start and end addresses of that entry; and iii) retrieving the address of the Nth byte of data from the target address stored in the entry, in case the input address is within the range of start and end addresses of that entry, wherein N is the difference between the input address and the start address stored in the entry. The sources comprises of any one of the followings such as local file system, network file system, database and web location, etc.

According to another embodiment of the invention, a non-transitory computer readable medium 120 is provided for accessing at least one temporal and spatial data from at least one source in a manifold system, including program instructions executable by a computer for the following steps:

Initially, the at least one temporal and spatial data from the at least one source to signals of the compute elements is mapped using a transitive element of the manifold system, wherein i) the transitive element specifies the relationship between a) a set of data elements, b) the data elements and the compute elements, or c) the compute elements; ii) the data elements along with their sources are declared using a transitive declaration.

In the final step, the at least one temporal and spatial data from the at least one source is accessed thereby mapping a source address to a target address using a channel by the following steps:

Initially, a channel map instance and an address are accepted as inputs. In the next step, for each entry in the channel map instance, whether the input address is within the range of start and end addresses of that entry is checked. In the next step, the address of the Nth byte of data from the target address stored in the entry is retrieved, in case the input address is within the range of start and end addresses of that entry, wherein N is the difference between the input address and the start address stored in the entry. The sources comprises of any one of the followings such as local file system, network file system, database and web location, etc.

According to another embodiment of the invention, a computer program is provided, the program comprising program code stored in a non-transitory computer readable medium 120, the program code executable by a computer 110 to carry out the method of accessing at least one temporal and spatial data from at least one source in a manifold system.

According to another embodiment of the invention, a computer program is provided, the program comprising program code stored in a non-transitory computer readable medium 120, the program code executable by a computer 110 to carry out the method of accessing at least one temporal and spatial data from at least one source in a manifold system, the program code arranged for being integrated in or added to a computer application for joint execution of said computer program and said computer application by said computer 110.

According to another embodiment of the invention, a computer program product is provided, the product comprising program code stored on a non-transitory computer readable medium 120, the program code readable by a computer 110, which operates to carry out the method of accessing at least one temporal and spatial data from at least one source in a manifold system, when said program code is executed by said computer 110.

According to another embodiment of the invention, a computer program product is provided, the product comprising program code stored on a non-transitory computer readable medium 120, the program code readable by a computer 110, which is operable to carry out the method of accessing at least one temporal and spatial data from at least one source in a manifold system, and further comprising integrating said program code into a computer application for joint execution of said program code and said computer application by said computer 110.

The methods, systems, apparatuses, non-transitory computer readable mediums, computer programs and computer program products of the present invention find application in the areas of computer graphics, image processing, aerodynamic modeling, big data applications such as query processing, analytics, mapping, machine learning, cognitive element computing, 2-D, 3-D Chip design, multi-core computing, shape computing, topological computing, 3-D printing, robotics, Internet of Things (I-o-T), Swarm Internet of Things, Cognitive I-o-T, medical imaging, space modeling, environmental modeling, distributed operating system, mobile network simulation, N-tier Service Oriented Architecture (SOA), Self-Programmable Gate Array (SPGA) Design, SPGA Application Design, and design slicing using model layer extension.

It will be appreciated that the above description for clarity has described embodiments of the invention with reference to different functional units and processors. However, it will be apparent that any suitable distribution of functionality between different functional units, or processors/computers may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order.

### ADVANTAGES OF THE INVENTION

The methods, apparatuses and systems of the proposed invention can be used for
1) providing highly generic autonomous computing system or agent which is a significant improvement over existing computing systems; and
2) accessing at least one temporal and spatial data from external sources in a manifold system as well as providing uniformity in accessing the data from the external sources.

We claim:

1) A manifold system comprising:
at least one manifold frame comprising
an initial manifold configuration model, and
a set of manifold planes,
wherein each manifold plane comprises of a set of manifold elements, said manifold element is a concrete specialization of an abstract dimensioned entity supporting manifold operations and variably progresses from manifold frame to frame in manifold time units through manifold system operations in a real, virtual or a combination of real and virtual operating environment thereby performing useful work or duty.

2) The manifold system as claimed in claim 1, wherein the manifold operations comprises of configuration, projection, forming and/or transforming.

3) The manifold system as claimed in claim 1, wherein the concrete specializations comprises of compute elements, cognitive elements, transitive elements, processors, and/or transducer elements, or composite of these elements or composite of planes of these elements.

4) The manifold system as claimed in claim 1, wherein the manifold system operations comprises of forming, transforming, projecting, computing, learning and/or transducing.

5) The manifold system as claimed in claim 1, wherein the operating environment comprises of any one of the followings such as desktop operating system, distributed operating system, embedded operating system, field programmable gate array system, virtual system, or combination of real and virtual systems.

6) The manifold system as claimed in claim 1, wherein the manifold system is an autonomous computing system.

7) The manifold system as claimed in claim 1, wherein the manifold system is an autonomous agent.

8) The manifold system as claimed in claim 1, wherein the manifold system is realized as any one of the followings:
a) single-core system;
b) multi-core system;
c) heterogeneous multi-core system;
d) single-node system;
e) multi-node system;
f) heterogeneous multi-node system;
g) application-specific network of network-on-chip architecture;
h) distributed computing system; and
i) simulated system.

9) A method of realizing a manifold system from input models, in which steps thereof are implemented by a computer, the method comprising:
a) modeling a computational manifold as multiple planes of compute elements conforming to behavioral models and their relationships;
b) modeling a data manifold as multiple planes of problem elements;
c) modeling a projection of the data manifold onto the computational manifold;
d) synthesizing a manifold system of required model type and level of abstraction; and
e) synthesizing a schedule which projecting the data manifold onto the computational manifold to solve a given problem.

10) The method as claimed in claim 9, wherein the computational manifold and the data manifold are modeled using a declarative programming language.

11) The method as claimed in claim 9, wherein the computational manifold and data manifold are modeled using extensions to existing procedural programming languages.

12) The method as claimed in claim 9, wherein the projection is modeled using play statements.

13) The method as claimed in claim 9, wherein the manifold system is synthesized using multi-ladder approach.

14) The method as claimed in claim 9, wherein manifold elements of the manifold system may be synthesized at different levels of abstraction.

15) The method as claimed in claim 9, wherein compute element, cognitive element and transducer element of the manifold system may be realized using any one of the followings such as transistor logic, boolean logic, quantum computing logic, software logic, or a combination of transistor logic, boolean logic, quantum computing logic and software logic.

16) The method as claimed in claim 15, wherein the compute element, cognitive element and transducer element may be realized as software components either for simulation or for distributed computing.

17) The method as claimed in claim 9, wherein transitive elements of the manifold system may be realized as any one of the followings such as software library, hardware channels or a combination of software library and hardware channels.

18) The method as claimed in claim 10, wherein the declarative programming language supports declaration of processor architectural models in a program.

19) The method as claimed in claim 11, wherein the extensions to existing procedural programming languages includes support for declaring processor architectural models in a program.

20) The method as claimed in claim 15, wherein a model of the compute element may use any one of the operators declared either in operator models or in space-time models.

21) The method as claimed in claim 20, wherein the model of the compute element specifies an affinity for a processor architectural model.

22) The method as claimed in claim 20, wherein the operators declared either in operator models or in space-time models may be realized using any one of the followings such as sequential logic, parallel logic, boolean logic or quantum computer logic.

23) The method as claimed in claim 13, wherein an input to the synthesis process is any one of the followings:
a) high-level description of problem elements and computations elements;
b) C/C++ component model describing the structure and behavior of manifold elements;
c) processor architectural model;
d) space-time model;
e) operator model;
f) an intermediate level description of the structure and behavior of manifold elements;
g) high-level description of problem elements and computations elements;
h) C program;
i) an assembly language program;
j) register-transfer level description of the structure and behavior of manifold elements;
k) logic gate-level description of the structure and behavior of manifold elements; and
l) transistor-level description of the structure and behavior of manifold elements.

24) The method as claimed in claim 13, wherein an output of the synthesis process is any one of the followings:
a) C/C++ component model describing the structure and behavior of manifold elements;
b) intermediate level description of the structure and behavior of manifold elements;
c) C/C++ model for simulation;
d) distributed component model describing the structure and behavior of manifold elements;
e) register-transfer level description of the structure and behavior of manifold elements;
f) logic gate-level description of the structure and behavior of manifold elements;
g) transistor-level description of the structure and behavior of manifold elements;
h) integrated circuit layout description;
i) assembly language program;
j) relocatable object module;
k) executable program;
l) processor abstraction layer library;
m) hardware abstraction layer library; and
n) set of test cases for processor verification.

25) An apparatus for realizing a manifold system from input models, comprising:
a) means for modeling a computational manifold as multiple planes of compute elements conforming to behavioral models and their relationships;
b) means for modeling a data manifold as multiple planes of problem elements;
c) means for modeling a projection of the data manifold onto the computational manifold;
d) means for synthesizing a manifold system of required model type and level of abstraction; and
e) means for synthesizing a schedule which projecting the data manifold onto the computational manifold to solve a given problem.

26) A non-transitory computer readable medium for realizing a manifold system from input models, including program instructions executable by a computer for:
a) modeling a computational manifold as multiple planes of compute elements conforming to behavioral models and their relationships;
b) modeling a data manifold as multiple planes of problem elements;
c) modeling a projection of the data manifold onto the computational manifold;
d) synthesizing a manifold system of required model type and level of abstraction; and
e) synthesizing a schedule which projecting the data manifold onto the computational manifold to solve a given problem.

27) A computer program, comprising program code stored in a non-transitory computer readable medium, the program code executable by a computer to carry out the method as claimed in claim 9.

28) A computer program, comprising program code stored in a non-transitory computer readable medium, the program code executable by a computer to carry out the method as claimed in claim 9, the program code arranged for being integrated in or added to a computer application for joint execution of said computer program and said computer application by said computer.

29) A computer program product comprising program code stored on a non-transitory computer readable medium, the program code readable by a computer, which operates to carry out the method as claimed in claim 9, when said program code is executed by said computer.

30) A computer program product comprising program code stored on a non-transitory computer readable medium, the program code readable by a computer, which is operable to carry out the method as claimed in claim 9, and further comprising integrating said program code into a computer application for joint execution of said program code and said computer application by said computer.

31) A method of accessing at least one temporal and spatial data from at least one source in a manifold system, the method comprising:
a) mapping the at least one temporal and spatial data from the at least one source to signals of the compute elements using a transitive element of the manifold system, wherein
i. the transitive element specifies the relationship between a) a set of data elements, b) the data elements and the compute elements, or c) the compute elements;
ii. the data elements along with their sources are declared using a transitive declaration;
b) accessing the at least one temporal and spatial data from the at least one source thereby mapping a source address to a target address using a channel by:
i. accepting a channel map instance and an address as inputs;
ii. for each entry in the channel map instance, checking whether the input address is within the range of start and end addresses of that entry; and
iii. retrieving the address of the Nth byte of data from the target address stored in the entry, in case the input address is within the range of start and end addresses of that entry, wherein N is the difference between the input address and the start address stored in the entry.

32) The method as claimed in claim 31, wherein the source comprises of any one of the followings such as local file system, network file system, database or web location.

33) An apparatus for accessing temporal and spatial data from at least one source in a manifold system, comprising:
a) means for mapping the at least one temporal and spatial data from the at least one source to signals of the compute elements using a transitive element of the manifold system, wherein
i. the transitive element specifies the relationship between a) a set of data elements, b) the data elements and the compute elements, or c) the compute elements;
ii. the data elements along with their sources are declared using a transitive declaration;
b) means for accessing the at least one temporal and spatial data from the at least one source thereby mapping a source address to a target address using a channel by:
i. accepting a channel map instance and an address as inputs;
ii. for each entry in the channel map instance, checking whether the input address is within the range of start and end addresses of that entry; and
iii. retrieving the address of the Nth byte of data from the target address stored in the entry, in case the input address is within the range of start and end addresses of that entry, wherein N is the difference between the input address and the start address stored in the entry.

34) A non-transitory computer readable medium for accessing temporal and spatial data from at least one source in a manifold system, including program instructions executable by a computer for:
a) mapping the at least one temporal and spatial data from the at least one source to signals of the compute elements using a transitive element of the manifold system, wherein
i. the transitive element specifies the relationship between a) a set of data elements, b) the data elements and the compute elements, or c) the compute elements;
ii. the data elements along with their sources are declared using a transitive declaration;
b) accessing the at least one temporal and spatial data from the at least one source thereby mapping a source address to a target address using a channel by:
i. accepting a channel map instance and an address as inputs;
ii. for each entry in the channel map instance, checking whether the input address is within the range of start and end addresses of that entry; and
iii. retrieving the address of the Nth byte of data from the target address stored in the entry, in case the input address is within the range of start and end addresses of that entry, wherein N is the difference between the input address and the start address stored in the entry.

35) A computer program, comprising program code stored in a non-transitory computer readable medium, the program code executable by a computer to carry out the method as claimed in claim 31.

36) A computer program, comprising program code stored in a non-transitory computer readable medium, the program code executable by a computer to carry out the method as claimed in claim 31, the program code arranged for being integrated in or added to a computer application for joint execution of said computer program and said computer application by said computer.

37) A computer program product comprising program code stored on a non-transitory computer readable medium, the program code readable by a computer, which operates to carry out the method as claimed in claim 31, when said program code is executed by said computer.

38) A computer program product comprising program code stored on a non-transitory computer readable medium, the program code readable by a computer, which is operable to carry out the method as claimed in claim 31, and further comprising integrating said program code into a computer application for joint execution of said program code and said computer application by said computer.
